(19) United States
(12) Patent Application Publication
(10) Pub. No.: US 2026/0349472 A1
(43) Pub. Date: Nov. 5, 2026

(54) SYSTEM AND METHOD OF OPERATIVELY COUPLING AUGMENTED REALITY (AR) GLASSES WITH A CONTROL COMPUTING DEVICE USING A MAGNETIC CORD CONNECTOR WITH VARIABLE CORD POSITIONALITY

(71) Applicant: Dell Products LP, Round Rock, TX (US)

(72) Inventors: Loo Shing Tan, Singapore (SG); Michiel Sebastiaan Emanuel Petrus Knoppert, Amsterdam (NL); Gerald Rene Pelissier, Santa Clara, CA (US); Jarrett Simerson, Northbrook, IL (US)

(73) Assignee: Dell Products LP, Round Rock, TX (US)

(21) Appl. No.: 19/194,974

(22) Filed: Apr. 30, 2025

(51) Int. Cl. G06F 1/16; G06F 1/26; G06F 3/0354

(52) U.S. Cl. CPC G06F 1/1632; G06F 1/1635; G06F 1/1639; G06F 1/1683; G06F 1/1684; G06F 1/266; G06F 3/03547

(57) ABSTRACT

An augmented reality/virtual reality (AR/VR) glasses mobile clip device or docking station may comprise a housing for operative coupling with an AR/VR control modular computing device that generates images for display within AR/VR glasses operatively coupled to the AR/VR glasses mobile clip device or docking station via a power and data transfer cord and a universal magnetic and detachable cord connector for magnetic attachment to a glasses power and data port with the housing of the universal magnetic and detachable cord connector providing multiple cord positioning channels for user selection of cord orientation with respect to the AR/VR glasses. A retractable spooling device for winding of the cord into a stowed position upon disconnection of the AR/VR glasses in a magnetic cradle of a cord channel in the housing of the AR/VR glasses mobile clip or docking station.

### FIELD OF THE DISCLOSURE

The present disclosure generally relates to augmented reality (AR) or virtual reality (VR) glasses or headsets that operatively couple with an information handling system to display media to a user for the information handling system. The present disclosure more specifically relates to a system and method for forming a wired connection between AR/VR glasses and an AR/VR control modular computing device, via a cord operatively coupled to a touch drawing pad, an AR/VR mobile glasses clip device, or an AR/VR control modular computing device docking station and having variable cord positionality with respect to the user to suit the user's preferences and ease the user's movement around the workspace.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be operatively or wirelessly coupled to a digital display device, such as AR/VR glasses, for output of images or sound of digital media for a user.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an augmented reality/virtual reality (AR/VR) control modular computing device executing machine readable code instructions to generate and orchestrate the display of AR/VR images via operably coupled AR/VR glasses according to an embodiment of the present disclosure;

FIG. 2 is a block diagram illustrating an AR/VR control modular computing device docking station with an AR/VR control modular computing device operably coupled to AR/VR glasses according to an embodiment of the present disclosure;

FIG. 3A is a graphical diagram illustrating an AR/VR control modular computing device docking station operably coupled to AR/VR glasses and to an AR/VR control modular computing device according to an embodiment of the present disclosure;

FIG. 3B is a graphical diagram illustrating an AR/VR control modular computing device docking station for facilitating control of AR/VR glasses with an operably coupled external augmented hardware processor device and an operably coupled AR/VR control modular computing device in a user workspace according to an embodiment of the present disclosure;

FIG. 3C is a graphical diagram illustrating an AR/VR control modular computing device docking station for facilitating control of AR/VR glasses with an operably coupled AR/VR control modular computing device and one or more operably coupled input/output devices in a user workspace, including a touch drawing pad with incorporated AR/VR glasses connector cord according to an embodiment of the present disclosure;

FIG. 3D is a graphical diagram illustrating an AR/VR glasses mobile clip device operably coupled to AR/VR glasses and to an AR/VR control modular computing device for mobile use of the AR/VR glasses according to an embodiment of the present disclosure;

FIG. 4 is a graphical diagram illustrating an AR/VR control modular computing device for forming a secure, operable connection with either an AR/VR control modular computing device docking station or an AR/VR glasses mobile clip device according to an embodiment of the present disclosure;

FIG. 5A is a graphical diagram illustrating AR/VR glasses having an temple-mounted a glasses power and data port for operative coupling with a magnetic and detachable cord connector via reciprocal magnetic stays in the glasses power and data port and the magnetic and detachable cord connector according to an embodiment of the present disclosure;

FIG. 5B is a graphical diagram illustrating AR/VR glasses having a wired connection that may be easily adjusted or detached to avoid inadvertent movement of an operatively coupled touch drawing pad, AR/VR mobile clip device, or AR/VR control modular computing device docking station in a user workspace according to an embodiment of the present disclosure;

FIG. 5C is a graphical diagram illustrating a magnetic and detachable cord connector with placement of an AR/VR power and data transfer cord in a straight configuration within a cord positioning channel in a magnetic and detachable cord connector housing according to an embodiment of the present disclosure;

FIG. 5D is a graphical diagram illustrating a magnetic and detachable cord connector with placement of an AR/VR power and data transfer cord in a down configuration within a cord positioning channel in a magnetic and detachable cord connector housing according to an embodiment of the present disclosure;

FIG. 5E is a graphical diagram illustrating a magnetic and detachable cord connector with placement of an AR/VR power and data transfer cord in an up configuration within a cord positioning channel in a magnetic and detachable cord connector housing according to an embodiment of the present disclosure;

FIG. 6A is a graphical diagram illustrating a bottom view of a touch drawing pad housing for an AR/VR power and data transfer cord for connecting to AR/VR glasses that may be oriented to exit either the right or left side of the touch drawing pad according to an embodiment of the present disclosure;

FIG. 6B is a graphical diagram illustrating a bottom view of a touch drawing pad housing that includes a cord winding mount for storage of an AR/VR power and data transfer cord for connecting to AR/VR glasses according to an embodiment of the present disclosure;

FIG. 6C is a graphical diagram illustrating a bottom view of a touch drawing pad housing with a stored AR/VR power and data transfer cord for connection to AR/VR glasses having a magnetic and detachable cord connector connected to a magnetic cradle according to an embodiment of the present disclosure;

FIG. 7A is a graphical diagram illustrating an AR/VR glasses mobile clip device housing a retractable AR/VR glasses cable for operably connecting to AR/VR glasses during mobile use of the AR/VR glasses according to an embodiment of the present disclosure;

FIG. 7B is a graphical diagram illustrating an AR/VR glasses mobile clip device housing a retracted and magnetically secured AR/VR glasses cable in a magnetic cradle for storage of the AR/VR glasses cable when not in mobile use according to an embodiment of the present disclosure; and

FIG. 8 is a flow diagram illustrating a method of connecting and disconnecting an AR/VR control modular computing device with AR/VR glasses using a magnetic and detachable cord connector that can be positioned in a plurality of orientations with respect to the AR/VR glasses according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

As computing processing capabilities grow, so too does a need for more room to display content for user interaction, such as across a plurality of digital display devices, for example. Another solution to such a need is to combine digital display devices with augmented reality or virtual reality (AR/VR) glasses within a user workspace environment that can further display holographic projected images of digital content, either in combination with, or in place of digital display devices such as computer monitors. Simultaneously, changes in working environments require that users be flexible to work in different locales, such as within the office, the home, public spaces, or on the move meaning user workspace environments may change. Users desire the same computing experience and level of privacy that they enjoy in more controlled environments, such as their home or their office, across each of these potential working locales. Use of AR/VR glasses can provide private, repeatable, location independent user experiences, and relieve physical world limitations, such as screen sizes of physical screens.

Using AR/VR glasses allows users to organize a virtual workspace in the user workspace environment around themselves, projected on top of the real world. Interactions in this user workspace environment with the virtual workspace use familiar peripherals such as a keyboard, touchpad, and a mouse, for easy adoption and support for existing applications. AR/VR glasses further allow users to visualize their virtual workspace in a format only viewable by the user themselves, allowing them to work, or enjoy a movie in privacy anywhere. In some embodiments of the present disclosure, such portability and security are provided for with an ecosystem of devices for various user workspace environments that include AR/VR glasses, an AR/VR glasses mobile clip device for mobile use of the AR/VR glasses, and an AR/VR control modular computing device for generating and orchestrating the display of digital content within the AR/VR glasses. Each of these devices may be stored in a single carrying case. Further, the AR/VR glasses mobile clip device may include a retractable and magnetically securable cord for connecting the AR/VR glasses to the AR/VR glasses mobile clip device and a secure connector for slidable attachment and detachment of the AR/VR glasses mobile clip device to the AR/VR control modular computing device. In other embodiments of the present disclosure, such a secure stationary user workspace may be alternatively provided for with an ecosystem of devices for various user workspace environments that include AR/VR glasses, an AR/VR control modular computing device docking station for desktop use of the AR/VR glasses, and an AR/VR control modular computing device for generating and orchestrating the display of digital content within the AR/VR glasses. The same secure connector within the AR/VR control modular computing device may further allow for slidable attachment and detachment of an AR/VR control modular computing device docking station for additional operable connection of the AR/VR control modular computing device to additional input/output devices, including a touch drawing pad, external augmented hardware processor devices, or a digital display device to increase productivity of the AR/VR control modular computing device.

Existing systems that employ such AR/VR glasses present significant challenges in terms of user comfort and flexibility, due to a requirement of a wired connection between the AR/VR glasses and at least one of these devices, through a physical cord or tether. Use of such a physical cord or tether for a wired connection provides more robust and less expensive access to enhanced hardware processing resources for managing image generation and display of images and location with AR/VR glasses than current available wireless connections. Currently, such tethered cables are fixed in position and length, which restrict the user's mobility within the user workspace environment with limits on the adaptability of placement of various devices in the user workspace ecosystem to individual user preferences. For example, existing systems may cause the cord to inhibit movement for a left-handed user or may prevent a user from easily moving around or standing up without causing inadvertent movement or even dropping of one of the devices operatively coupled to the AR/VR glasses in the user workspace. More specifically, the point at which the cable attaches to the AR/VR glasses in existing systems is fixed and cannot be altered to attach to a left or right side of the AR/VR glasses, or to position the cord to drape in a move comfortable position past the user's head as it leaves the AR/VR glasses. Additionally, the length of the cable in existing systems is fixed, which can be restrictive for users who frequently move around their user workspace environment, or can cause a longer cord to get in the way or get snagged behind or underneath office furniture or the like.

Embodiments of the present disclosure address these issues by providing a retractable AR/VR power and data transfer cord for operative connection between the AR/VR glasses and the touch drawing pad, AR/VR glasses mobile clip, or AR/VR control modular computing device docking station. Such a retractable AR/VR power and data transfer cord in embodiments herein may have a variable length which may be adjusted by user retraction or withdrawal of the AR/VR power and data transfer cord from a cord housing within one of these operably coupled devices. Further, each of these retractable AR/VR power and data transfer cords may have a universal magnetic and detachable cord connector, each of which may be used to detachably and magnetically connect to a power and data port housed in either or both temples or arms of the AR/VR glasses. Additionally, the universal magnetic and detachable cord connector may include a plurality of cord positioning channels in the cord connector housing that allow the user to adjust the AR/VR power and data transfer cord in a cord connector cavity of the cord connector housing in one of a plurality of positions in embodiments herein. The plurality of positions for the AR/VR power and data transfer cord in the cord positioning channels may include a straight configuration, an upward configuration, and a downward configuration that define the angle at which the cord drapes behind the user in an example embodiment. In such a way, embodiments of the present disclosure may allow for variable cord length, variable point of attachment on the AR/VR glasses for such an AR/VR power and data transfer cord, and variable cord draping angles with respect to the user, to maximize user comfort and flexibility within a user workspace environment that is stationary or mobile.

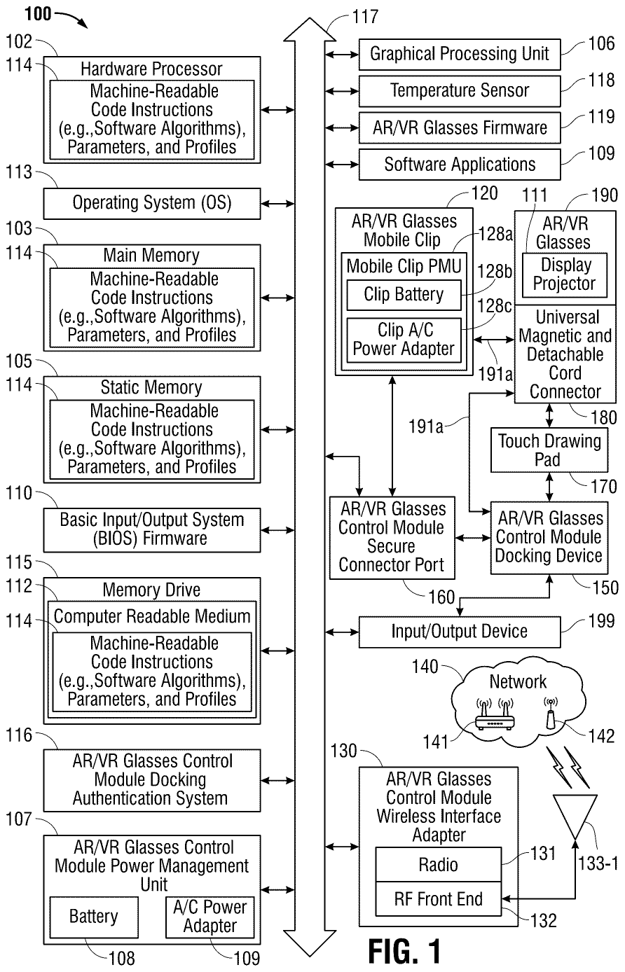

Turning now to the figures, FIG. 1 illustrates an information handling system 100 similar to the information handling systems according to several aspects of the present disclosure. An ecosystem of devices of a mobile user workspace are described in an embodiment herein, which include AR/VR glasses 190, an AR/VR glasses mobile clip device 120 for mobile use of the AR/VR glasses 190, and an AR/VR control modular computing device 100 for generating and orchestrating the display of digital content within the AR/VR glasses 190 using the display projector electronics 111. The AR/VR control modular computing device 100 may operatively couple with either the AR/VR glasses mobile clip device 120 for mobile use or the AR/VR control modular computing device docking station 150 during desktop use. Further, an ecosystem of device of a stationary user workspace are also described in an embodiment herein, which include AR/VR glasses 190, an AR/VR control modular computing device docking station 150 for stationary or desktop use of the AR/VR glasses 190, and an AR/VR control modular computing device 100 for generating and orchestrating the display of digital content within the AR/VR glasses 190 using the display projector 111 in embodiments herein.

The AR/VR glasses 190 in an embodiment may be operatively coupled to the AR/VR glasses mobile clip device 120, via a AR/VR glasses data and power transfer cord 191a (e.g., Universal Serial Bus (USB)-C cord) that is retractable. In other embodiments, the AR/VR glasses 190 in an embodiment may be operatively coupled to the AR/VR control modular computing device docking station 150 via a AR/VR glasses data and power transfer cord 191a that is retractable. In some embodiments, AR/VR glasses mobile clip device 120 or AR/VR control modular computing device docking station 150 may further be operatively coupled to the AR/VR control modular computing device 100 via an AR/VR control modular computing device secure connector port 160 formed in the housing of the AR/VR control modular computing device 100. The AR/VR control modular computing device secure connector port 160 is actuatable into a secure mating channel in the housing of the AR/VR control modular computing device 100 in some embodiments or on a secure mating rail in other embodiments. In an example embodiment, the AR/VR control modular computing device secure connector port 160 actuated into the secure mating channel may engage with a secure connector pin mount on a secure mating rail of the AR/VR glasses mobile clip device 120 or on the AR/VR control modular computing device docking station 150. The AR/VR control modular computing device 100 engages with either the AR/VR control modular computing device docking station 150 or the AR/VR glasses mobile clip device 120 through slidable attachment and detachment with the secure mating channel and the reciprocal secure mating rail. In embodiments herein, the secure mating rail slides into the secure mating channel of the AR/VR control modular computing device 100 until the secure connector pin mount aligns with the AR/VR control modular computing device secure connector port being urged into the secure mating channel. In this way, power and communication operative coupling may be established between the AR/VR glasses mobile clip device 120 or the AR/VR control modular computing device docking station 150 and the AR/VR control modular computing device 100 in embodiments herein.

The AR/VR glasses 190 in an embodiment may also be operatively coupled to the AR/VR control modular computing device docking station 150, a touch drawing pad 170 or keyboard, via a AR/VR glasses data and power transfer cord 191b (e.g., Universal Serial Bus (USB)-C cord) during stationary or desktop usage. The AR/VR glasses data and power transfer cord 191b may be similar to AR/VR glasses data and power transfer cord 191a, but not retractable and instead used with operative coupling the AR/VR control modular computing device docking station 150 such as via a touch drawing pad 170 or keyboard within a desktop user workspace having a different cord mount winding storage system. The AR/VR control modular computing device docking station 150 may further be operatively coupled to the AR/VR control modular computing device 100 via the AR/VR control modular computing device secure connector port 160 formed through slidable attachment and detachment of the AR/VR control modular computing device docking station 150 to the AR/VR control modular computing device 100. In this way, the AR/VR control modular computing device docking station 150 and/or the AR/VR control modular computing device 100 may operate to control and provide enhanced hardware processing resources to the AR/VR glasses 190.

The AR/VR control modular computing device 100 in an embodiment may draw power via the AR/VR control modular computing device secure connector port 160 formed by mating with the AR/VR control modular computing device docking station 150, or by application of DC voltage via the A/C power adapter 109 or battery 108. The AR/VR glasses 190 in an embodiment may be powered directly via the AR/VR glasses data and power transfer cord 191a or 191b, respectively, from the AR/VR control modular computing device docking station 150 or from the AR/VR glasses mobile clip device 120 having either a clip battery 128b or clip A/C power adapter 128c.

The AR/VR control modular computing device docking station 150 in an embodiment may be operably coupled to one or more external input/output devices 199, including touch drawing pad 170, a digital display device, a keyboard device, a touchpad device, a mouse or pointer device or other external/input output devices (not shown) in various user workspaces, via wired or wireless connection, for example. In an embodiment, power and data may be transferred via an AR/VR glasses data and power transfer cord 191a or 191b between the AR/VR glasses 190 and the AR/VR control modular computing device 100, via the touch drawing pad 170, the AR/VR glasses mobile clip device 120, or the AR/VR control modular computing device docking station 150. The AR/VR control modular computing device 100 may allow power transfer or transfer of data, via the power or data transfer connection formed by electrically conductive contact with pin contact pads in a glasses power and data port on either temple or arm of the AR/VR glasses 190, and pin contacts in a universal magnetic and detachable cord connector 180 at the end of the AR/VR glasses data and power transfer cord 191a or 191b. This universal magnetic and detachable cord connector 180 at the end of the AR/VR glasses data and power transfer cord 191a or 191b operatively and magnetically coupled to the glasses power and data port on either temple of the AR/VR glasses 190 to form the power and data connection between the AR/VR glasses 190 and any of the touch drawing pad 170, the AR/VR mobile clip device 120, or the AR/VR control modular computing device docking station 150 in embodiments herein. Such electrically conductive contact may form, for example, a USB-C connection between the AR/VR control modular computing device 100 and the AR/VR glasses 190, via the touch drawing pad 170, AR/VR glasses mobile clip device 120, or the AR/VR control modular computing device docking station 150.

A secure connector port cable within the AR/VR control modular computing device secure connector port 160 may be operatively coupled with a bus 117 of the AR/VR control modular computing device 100 in an embodiment for the transfer of power and data between the AR/VR control modular computing device 100 and the AR/VR control modular computing device docking station 150 or AR/VR glasses mobile clip device 120 in various embodiments herein. The AR/VR control modular computing device secure connector port 160 may be formed with a plurality of pin ports in a secure connector pin port housing movable into a secure mating channel. With the AR/VR control modular computing device secure connector port 160 engages, the plurality of pin ports in the secure connector pin port housing may engage with a plurality of pin contacts within a secure connector pin mount in a secure mating rail of either the AR/VR glasses mobile clip device 120 or the AR/VR control modular computing device docking station 150. This forms an electrically conductive contact for the pin ports within a secure connector pin port housing of the AR/VR control modular computing device 100 with either the AR/VR glasses mobile clip device 120 or the AR/VR control modular computing device docking station 150. Such an electrically conductive contact in an embodiment may complete a power or data transfer connection, such as a Universal Serial Bus (USB-C) connection, for example, between the AR/VR control modular computing device 100 and the AR/VR glasses mobile clip device 120 or AR/VR control modular computing device docking station 150.

A wired data transfer connection via the AR/VR glasses data and power transfer cord 191a or 191b and universal magnetic and detachable cord connector 180 may be established between the AR/VR glasses 190 and the AR/VR glasses mobile clip device 120 or the AR/VR control modular computing device docking station 150, respectively, in embodiments herein. In a further embodiment, a wired data transfer connection via the AR/VR glasses data and power transfer cord 191a or 191b and universal magnetic and detachable cord connector 180 may be established between the AR/VR glasses 190 and between the touch drawing pad 170 and the AR/VR control modular computing device docking station 150. The wired data transfer connection via the AR/VR glasses data and power transfer cord 191a or 191b and universal magnetic and detachable cord connector 180 may be established for the transfer of display data and location determination data from the AR/VR control modular computing device 100 executing machine readable code instructions of software applications 109 or firmware applications 119 for directing the display of generated AR/VR images at the display projector 111 of the AR/VR glasses 190 in embodiments herein. For example, the hardware processor 102 or graphical processing unit (GPU) 106 may execute machine readable code instructions of AR/VR glasses firmware 119 or software applications 109 to generate and display AR or VR projected images via a display projector 111 within the operatively coupled AR/VR glasses 190.

In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 141, a base station transceiver 142, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of computer readable code instructions to perform one or more computer functions, via one or more hardware processing resources.

The information handling system operating as the AR/VR control modular computing device 100 may include main memory 103, (volatile (e.g., random-access memory, etc.), or static memory 105, nonvolatile (read-only memory, flash memory etc.) or any combination thereof), one or more hardware processing resources, such as a hardware processor 102 that may be a central processing unit (CPU), a graphics processing unit (GPU) 106, other hardware controllers, or any combination thereof. Additional components of the information handling system operating as the AR/VR control modular computing device 100 may include one or more storage devices such as static memory 105 or drive unit 115. The information handling system operating as the AR/VR control modular computing device 100 may include or interface with one or more communications ports for communicating with external devices, as well as one or more input/output (IO) devices 199, a video/graphics digital display device, or any combination thereof. Portions of an information handling system 100 may themselves be considered information handling systems 100.

Information handling system operating as the AR/VR control modular computing device 100 may include devices or modules that embody one or more of the hardware devices or hardware processing resources executing machine readable code instructions for one or more systems and modules. The information handling system operating as the AR/VR control modular computing device 100 may execute machine readable code instructions (e.g., software or firmware algorithms), parameters, and profiles 114 that may operate on servers or systems, remote data centers, or on-box in individual client information handling systems according to various embodiments herein. In some embodiments, it is understood any or all portions of machine readable code instructions (e.g., software or firmware algorithms), parameters, and profiles 114 may operate on a plurality of information handling systems operating as the AR/VR control modular computing device 100.

The information handling system operating as the AR/VR control modular computing device 100 may include the hardware processor 102 such as a central processing unit (CPU) or other hardware processing resources on the AR/VR control modular computing device 100. Any of the hardware processing resources may operate to execute machine readable code instructions 114 that are either firmware or software code. The hardware processor 102 in the AR/VR control modular computing device 100 may comprise a vector CPU or multi-vector CPU or may be a graphics processing unit (GPU) 106 or other hardware processing resource. Hardware processor 102, GPU 106 or other hardware processing resources may execute machine readable code instructions 114 of one or more software applications 109 or AR/VR glasses firmware 119 in embodiments herein to generate digital display data or location determination data for AR/VR glasses 190, a digital display device or other input/output device 199 according to various embodiments herein.

Moreover, the information handling system operating as the AR/VR control modular computing device 100 may include memory such as main memory 103, static memory 105, and disk drive unit 115 (volatile (e.g., random-access memory, etc.), nonvolatile memory (read-only memory, flash memory etc.) or any combination thereof or other memory with computer readable medium 112 storing machine readable code instructions (e.g., software or firmware algorithms), parameters, and profiles 114 executable by the hardware processor 102, GPU 106, or any other hardware processing device. The information handling system 100 may also include one or more buses 117 operable to transmit communications between the various hardware components such as any combination of various I/O devices 199, as well as between hardware processors 102, GPU 106 or other, the operating system (OS) 113, the basic input/output system (BIOS) 110, the wireless interface adapter 130, or a radio module 131, among other components described herein. In an embodiment, the hardware processor 102, and/or GPU 106 may execute one or more bus drivers in order to transmit this data between the information handling system operating as the AR/VR control modular computing device 100 and the input/output devices 199 described herein.

A network interface device 130 of the information handling system operating as the AR/VR control modular computing device 100 may be wired or wireless such as shown with wireless interface adapter 130 that can provide wireless connectivity among devices such as with Bluetooth® or to a network 140, e.g., a wide area network (WAN), a local area network (LAN), wireless local area network (WLAN), a wireless personal area network (WPAN), a wireless wide area network (WWAN), or other network. In embodiments described herein, the wireless interface device 130 with its radio 131, RF front end 132 and antenna 133 is used to communicate with the network 140, via, for example, a Bluetooth® or Bluetooth® Low Energy (BLE) protocols, or other WPAN or WLAN protocols.

In an embodiment, a WAN, WWAN, LAN, and WLAN may each include an AP 141 or base station 142 used to operatively couple the information handling system operating as the AR/VR control modular computing device 100, via a wireless interface adapter 130. In a specific embodiment, the network 140 may include macro-cellular connections via one or more base stations 142 or a wireless AP 141 (e.g., Wi-Fi), or such as through licensed or unlicensed WWAN small cell base stations 142. Connectivity may be via wired or wireless connection. For example, wireless network wireless APs 141 or base stations 142 may be operatively connected to the information handling system operating as the AR/VR control modular computing device 100. Wireless interface adapter 130 may include one or more radio frequency (RF) subsystems (e.g., radio 131) with transmitter/receiver circuitry, modem circuitry, one or more antenna RF front end circuits 132, one or more wireless controller circuits, amplifiers, antennas 133, and other circuitry of the radio 131, such as one or more antenna ports used for wireless communications via multiple radio access technologies (RATs). The radio 131 may communicate with one or more wireless technology protocols.

In an embodiment, the wireless interface adapter 130 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WiMAX, WWAN such as 3GPP or 3GPP 2, Bluetooth® standards, proprietary RF protocol, or similar wireless standards may be used. Utilization of radiofrequency communication bands according to several example embodiments of the present disclosure may include bands used with the WLAN standards which may operate in both licensed and unlicensed spectrums. For example, WLAN may use frequency bands such as those supported in the 802.11 a/h/j/n/ac/ax/be including Wi-Fi 6, Wi-Fi 6e, and the emerging Wi-Fi 7 standard. It is understood that any number of available channels may be available in WLAN under the 2.4 GHz, 5 GHz, or 6 GHz bands which may be shared communication frequency bands with WWAN protocols or Bluetooth® protocols in some embodiments. Wireless interface adapter 130 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 130 can represent an add-in card, wireless network interface module that is integrated with a main board of the information handling system operating as the AR/VR control modular computing device 100 or integrated with another wireless network interface capability, or any combination thereof.

In some embodiments, one or more hardware processors or hardware controllers executing software, firmware, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software machine readable code instructions executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium 112 that includes machine-readable code instructions, parameters, and profiles 114 or receives and executes instructions, parameters, and profiles 114 responsive to a propagated signal, so that a hardware device connected to a network 140 may communicate voice, video, or data over the network 140. Further, the machine readable code instructions 114 may be transmitted or received over the network 140 via the network interface device or wireless interface adapter 130. The information handling system 100 may include a set of instructions 114, that may be executed to cause the AR/VR control modular computing device 100 to perform any one or more of the methods or computer-based functions disclosed herein. For example, machine readable code instructions 114 may be executed by a hardware processor 102, GPU 106, or any other hardware processing resource and may include software agents, or other aspects or components used to execute the methods and systems described herein. Various software application modules 109 or firmware modules (e.g., AR/VR glasses firmware 119) comprising application machine readable code instructions 114 may be coordinated by an OS 113, and/or via an application programming interface (API) include a unified device API described herein. An example OS 113 may include Windows ®, Android ®, and other OS types. Example APIs may include Win 32, Core Java API, or Android APIs.

In an embodiment, the information handling system operating as the AR/VR control modular computing device 100 may include a disk drive unit 115. The disk drive unit 115 and may include machine-readable code instructions, parameters, and profiles 114 in which one or more sets of machine-readable code instructions, parameters, and profiles 114 such as firmware or software can be embedded to be executed by the hardware processor 102 or other hardware processing devices such as a GPU 106, or other microcontroller unit to perform the processes described herein. Similarly, main memory 103 and static memory 105 may also contain a computer-readable medium for storage of one or more sets of machine-readable code instructions, parameters, or profiles 114 described herein. The disk drive unit 115 or static memory 105 also contain space for data storage. Further, the machine-readable code instructions, parameters, and profiles 114 may embody one or more of the methods as described herein. In a particular embodiment, the machine-readable code instructions, parameters, and profiles 114 may reside completely, or at least partially, within the main memory 103, the static memory 105, and/or within the disk drive 115 during execution by the hardware processor 102, or GPU 106 of information handling system 100.

Main memory 103, or other memory of the embodiments described herein may contain computer-readable medium (not shown), such as RAM in an example embodiment. An example of main memory 103 includes random access memory (RAM) such as static RAM (SRAM), dynamic RAM (DRAM), non-volatile RAM (NV-RAM), or the like, read only memory (ROM), another type of memory, or a combination thereof. Static memory 105 may contain computer-readable medium (not shown), such as NOR or NAND flash memory in some example embodiments. The applications and associated APIs, for example, may be stored in static memory 105 or on the disk drive unit 115 that may include access to a machine-readable code instructions, parameters, and profiles 114 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system operating as the AR/VR control modular computing device 100 may further include a power management unit (PMU) 107 (a.k.a. a power supply unit (PSU)). The PMU 107 may include a hardware controller and executable machine-readable code instructions to manage the power provided to the components of the information handling system operating as the AR/VR control modular computing device 100 such as the hardware processor 102 and other hardware components described herein. The PMU 107 may control power to one or more components including the one or more drive units 115, the hardware processor 102 (e.g., CPU), the GPU 106, or other wired I/O devices 199 and other components that may require power when a power button has been actuated by a user. In an embodiment, the PMU 107 may monitor power levels and be electrically coupled to the information handling system operating as the AR/VR control modular computing device 100 to provide this power. The PMU 107 may be coupled to the bus 117 to provide or receive data or machine-readable code instructions. The PMU 107 may regulate power from a power source such as the battery 108 or AC power adapter 109. In an embodiment, the battery 108 may be charged via the AC power adapter 109 and provide power to the components of the information handling system operating as the AR/VR control modular computing device 100, via wired connections as applicable, or when AC power from the AC power adapter 109 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 112 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel ® brand processor, AMD ® brand processors, Qualcomm ® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

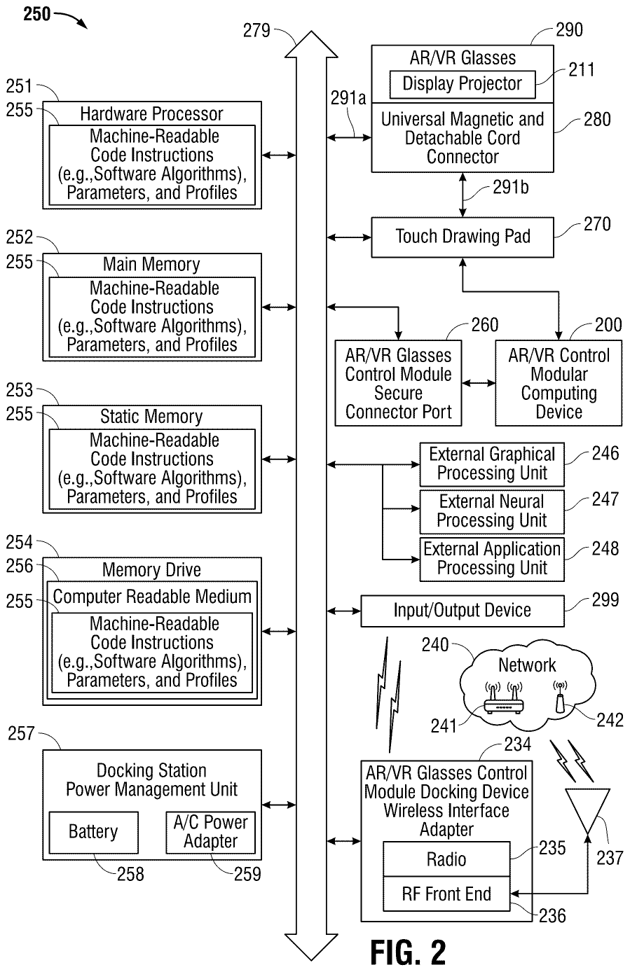

FIG. 2 is a block diagram illustrating an augmented reality/virtual reality (AR/VR) control modular computing device docking station 250 operatively coupled to an AR/VR control modular computing device 200 according to an embodiment of the present disclosure. As described herein, the AR/VR glasses 290 in an embodiment may be operatively coupled to the AR/VR control modular computing device docking station 250, via an AR/VR glasses data and power transfer cord 291a that may be retractable in some embodiments and having a universal magnetic and detachable cord connector 280 according to embodiments of the present disclosure. In other embodiments, the AR/VR glasses 290 in an embodiment may be operatively coupled to the AR/VR control modular computing device docking station 250 through a desktop touch drawing pad 270, which may include a keyboard, via an AR/VR glasses data and power transfer cord 291b that is stored using a cord mount storage system. The AR/VR control modular computing device docking station 250 in an embodiment may further be operatively coupled to the AR/VR control modular computing device 200 via an AR/VR control modular computing device secure connector port 260 engaged through slidable attachment and detachment of a secure mating channel and reciprocal secure mating rail between the AR/VR control modular computing device docking station 250 and the AR/VR control modular computing device 200. The AR/VR control modular computing device docking station 250 in an embodiment may be wired or wirelessly connected to one or more external input/output (I/O) devices 299, including a touch drawing pad 270, digital display device, keyboard, mouse, or other wired or wireless I/O devices in a user workspace ecosystem.

The AR/VR control modular computing device docking station 250 in an embodiment may include a hardware processor 251 for execution of machine readable code instructions 255 for software applications (e.g., 109 in FIG. 1) and the like in support of an operatively coupled AR/VR control modular computing device 200 for generating digital display data or AR/VR device location data for the AR/VR glasses 290 in an embodiment. The AR/VR control modular computing device docking station 250 may include augmented hardware processing resources onboard such as hardware processor 251 that may be additional graphics processing unit (GPU), neural processing unit (NPU), or application processing unit (APU) in an embodiment. The AR/VR control modular computing device docking station 250 in an embodiment may also be operatively coupled, via communication ports such as Universal Serial Bus (USB) ports (e.g., USB 3.0, USB-C), to one or more external input/output devices 299 or one or more external augmented hardware processor devices, such as a graphics processing unit (GPU) 246, neural processing unit (NPU) 247, or application processing unit (APU) 248, for example in other embodiments. This may allow the AR/VR control modular computing device 200 in an embodiment to leverage additional processing power of onboard hardware processor 251 or these external augmented hardware processor devices 246, 247, or 248 via the AR/VR control modular computing device docking station 250 to maximize performance of the AR/VR glasses 290 when in use.

The AR/VR control modular computing device 200 in an embodiment may draw power via engagement of the AR/VR control modular computing device secure connector port 260 formed by mating with the AR/VR control modular computing device docking station 250. The docking station battery 258 or docking station A/C power adapter 259 may provide power via the AR/VR control modular computing device secure connector port 260. The AR/VR glasses 290 in an embodiment may be powered directly via the AR/VR glasses data and power transfer cord 291a or 291b having a universal magnetic and detachable cord connector 280 from the AR/VR control modular computing device docking station 250 as well. A secure connector pin mount cable within the AR/VR control modular computing device docking station 250 may be operatively coupled via electrically conductive contact with secure connector pin connectors within the AR/VR control modular computing device secure connector port 260 to a bus of the AR/VR control modular computing device docking station 279 in an embodiment. This electrical coupling via secure connector pin ports in the AR/VR control modular computing device secure connector port 260 and pin contacts in the reciprocal secure connector pin mount may provide for transfer of power and data between the AR/VR control modular computing device 200 and the AR/VR control modular computing device docking station 250.

The information handling system operating as the AR/VR control modular computing device docking station 250 may include main memory 252, (volatile (e.g., random-access memory, etc.), or static memory 253, nonvolatile (read-only memory, flash memory etc.) or any combination thereof), one or more hardware processing resources, such as a hardware processor 251 that may be a central processing unit (CPU), a graphics processing unit (GPU), other hardware controllers, or any combination thereof, that may augment hardware processing resources for the AR/VR control modular computing device 200. Additional components of the information handling system operating as the AR/VR control modular computing device docking station 250 may include one or more storage devices such as static memory 253 or drive unit 254. The information handling system operating as the AR/VR control modular computing device docking station 250 may include or interface with one or more communications ports for communicating with external devices, as well as one or more input/output (IO) devices 299, touch drawing pad 270, a video/graphics digital display device, keyboard, mouse or other peripheral I/O devices or any combination thereof.

Information handling system operating as the AR/VR control modular computing device docking station 250 may include devices or modules that embody one or more of the hardware devices or hardware processing resources executing machine readable code instructions for one or more systems and modules. Any of the hardware processing resources, such as hardware processor 251, may operate to execute machine readable code instructions 255 that are either firmware or software code or may augment execution of machine readable code instructions executed with the AR/VR control modular computing device 200. The hardware processor 251 in the AR/VR control modular computing device docking station 250 may comprise a vector CPU or multi-vector CPU or may be a graphics processing unit (GPU) or other hardware processing resource and may execute software or firmware in conjunction with the operably coupled AR/VR control modular computing device 200 in embodiments herein.

Moreover, the information handling system operating as the AR/VR control modular computing device docking station 250 may include memory such as main memory 252, static memory 253, and disk drive unit 254 (volatile (e.g., random-access memory, etc.), nonvolatile memory (read-only memory, flash memory etc.) or any combination thereof or other memory with computer readable medium 256 storing machine readable code instructions (e.g., software or firmware algorithms), parameters, and profiles 255 executable by the hardware processor 251, or any other hardware processing device. The information handling system operating as the AR/VR control modular computing device docking station 250 may also include one or more buses 279 operable to transmit communications between the various hardware components such as any combination of various I/O devices 299, as well as between hardware processors 251 or other, the wireless interface adapter 234, or a radio module 235, among other components described herein. In an embodiment, the hardware processor 251 may execute one or more bus drivers in order to transmit this data between the information handling system operating as the AR/VR control modular computing device docking station 250 and the input/output devices 299, or touch drawing pad 270 described herein and the junction of the AR/VR glasses control module secure connector port 260 to a secure connector pin mount on the AR/VR control modular computing device 200 in embodiments herein.

A network interface device 234 of the information handling system operating as the AR/VR control modular computing device docking station 250 may be wired or wireless such as shown with wireless interface adapter 234 that can provide wireless connectivity among devices or to a network 240, e.g., a wide area network (WAN), a local area network (LAN), wireless local area network (WLAN), a wireless personal area network (WPAN), a wireless wide area network (WWAN), or other network via any wireless protocol. In embodiments described herein, the wireless interface device 234 with its radio 235, RF front end 236 and antenna 237 is used to communicate with the network 240, via, for example, a Bluetooth® or Bluetooth® Low Energy (BLE) protocols, or other WPAN or WLAN protocols.

In an embodiment, a WAN, WWAN, LAN, and WLAN may each include an AP 241 or base station 242 used to operatively couple the information handling system operating as the AR/VR control modular computing device docking station 250, via a wireless interface adapter 234. Wireless interface adapter 234 may include one or more radio frequency (RF) subsystems (e.g., radio 235) with transmitter/receiver circuitry, modem circuitry, one or more antenna RF front end circuits 236, one or more wireless controller circuits, amplifiers, antennas 237, and other circuitry of the radio 235, such as one or more antenna ports used for wireless communications via multiple radio access technologies (RATs). The radio 235 may communicate with one or more wireless technology protocols.

In an embodiment, the wireless interface adapter 234 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WiMAX, WWAN such as 3GPP or 3GPP2, Bluetooth® standards, proprietary RF protocol, or similar wireless standards may be used. Utilization of radiofrequency communication bands according to several example embodiments of the present disclosure may include bands used with the WLAN standards which may operate in both licensed and unlicensed spectrums. For example, WLAN may use frequency bands such as those supported in the 802.11 a/h/j/n/ac/ax/be including Wi-Fi 6, Wi-Fi 6e, and the emerging Wi-Fi 7 standard. It is understood that any number of available channels may be available in WLAN under the 2.4 GHz, 5 GHz, or 6 GHz bands which may be shared communication frequency bands with WWAN protocols or Bluetooth ® protocols in some embodiments. Wireless interface adapter 234 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 234 can represent an add-in card, wireless network interface module that is integrated with a main board of the information handling system operating as the AR/VR control modular computing device docking station 250 or integrated with another wireless network interface capability, or any combination thereof.

The present disclosure contemplates a computer-readable medium 256 that includes machine-readable code instructions, parameters, and profiles 255 or receives and executes instructions, parameters, and profiles 255 responsive to a propagated signal, so that a hardware device connected to a network 240 may communicate voice, video, or data over the network 240. Further, the machine readable code instructions 255 may be transmitted or received over the network 240 via the network interface device or wireless interface adapter 234. The information handling system operating as the AR/VR control modular computing device docking station 250 may include a set of instructions 255, that may be executed to cause the AR/VR control modular computing device docking station 250 to perform any one or more of the methods or computer-based functions disclosed herein. For example, machine readable code instructions 255 may be executed by a hardware processor 251, or any other hardware processing resource and may include software agents, or other aspects or components used to execute the methods and systems described herein.

In an embodiment, the information handling system operating as the AR/VR control modular computing device docking station 250 may include a disk drive unit 254. The disk drive unit 254 may include machine-readable code instructions, parameters, and profiles 255 in which one or more sets of machine-readable code instructions, parameters, and profiles 255 such as firmware or software can be embedded to be executed by the hardware processor 251 or other hardware processing devices, or other microcontroller units to perform the processes described herein. Similarly, main memory 252 and static memory 253 may also contain a computer-readable medium for storage of one or more sets of machine-readable code instructions, parameters, or profiles 255 described herein. The disk drive unit 254 or static memory 253 also contain space for data storage. Further, the machine-readable code instructions, parameters, and profiles 255 may embody one or more of the methods as described herein. In a particular embodiment, the machine-readable code instructions, parameters, and profiles 255 may reside completely, or at least partially, within the main memory 252, the static memory 253, and/or within the disk drive 254 during execution by the hardware processor 251 of information handling system operating as the AR/VR control modular computing device docking station 250.

Main memory 252, or other memory of the embodiments described herein may contain computer-readable medium (not shown), such as RAM in an example embodiment. An example of main memory 252 includes random access memory (RAM) such as static RAM (SRAM), dynamic RAM (DRAM), non-volatile RAM (NV-RAM), or the like, read only memory (ROM), another type of memory, or a combination thereof. Static memory 105 may contain computer-readable medium (not shown), such as NOR or NAND flash memory in some example embodiments. The applications and associated APIs, for example, may be stored in static memory 253 or on the disk drive unit 254 that may include access to a machine-readable code instructions, parameters, and profiles 255 such as a magnetic disk or flash memory in an example embodiment.

In an embodiment, the information handling system operating as the AR/VR control modular computing device docking station 250 may further include a power management unit (PMU) 257 (a.k.a. a power supply unit (PSU)). The PMU 257 may include a hardware controller and executable machine-readable code instructions to manage the power provided to the components of the information handling system operating as the AR/VR control modular computing device docking station 250 such as the hardware processor 251 and other hardware components described herein. The PMU 257 may control power to one or more components including the one or more drive units 254, the hardware processor 251 or other wired I/O devices 299, or touch drawing pad 270 and other components that may require power when a power button has been actuated by a user. In an embodiment, the PMU 257 may monitor power levels and be electrically coupled to the information handling system operating as the AR/VR control modular computing device docking station 250 to provide this power. The PMU 257 may be coupled to the bus 279 to provide or receive data or machine-readable code instructions. The PMU 257 may regulate power from a power source such as the battery 258 or AC power adapter 259. In an embodiment, the battery 258 may be charged via the AC power adapter 259 and provide power to the components of the information handling system operating as the AR/VR control modular computing device docking station 250, via wired connections as applicable, or when AC power from the AC power adapter 259 is removed.

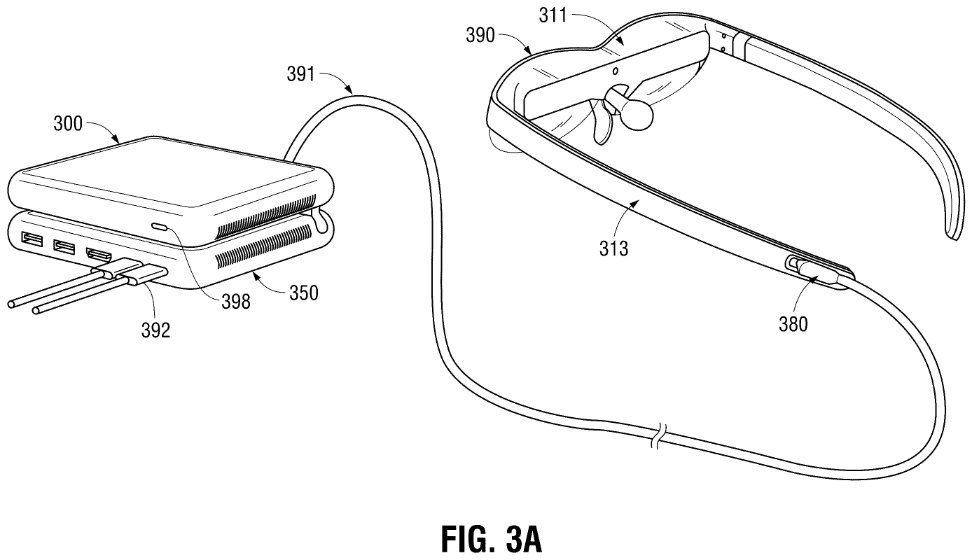

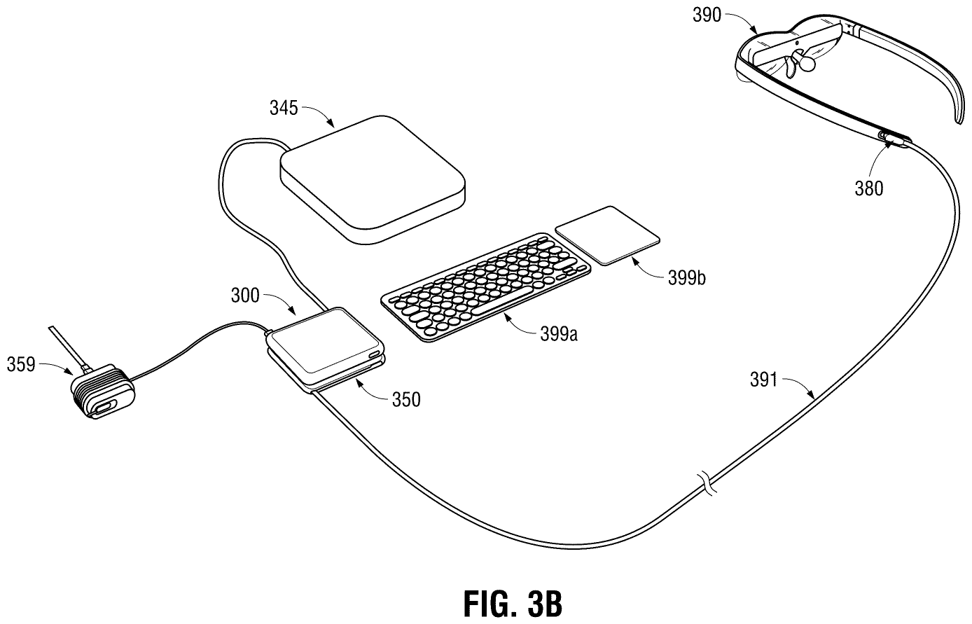

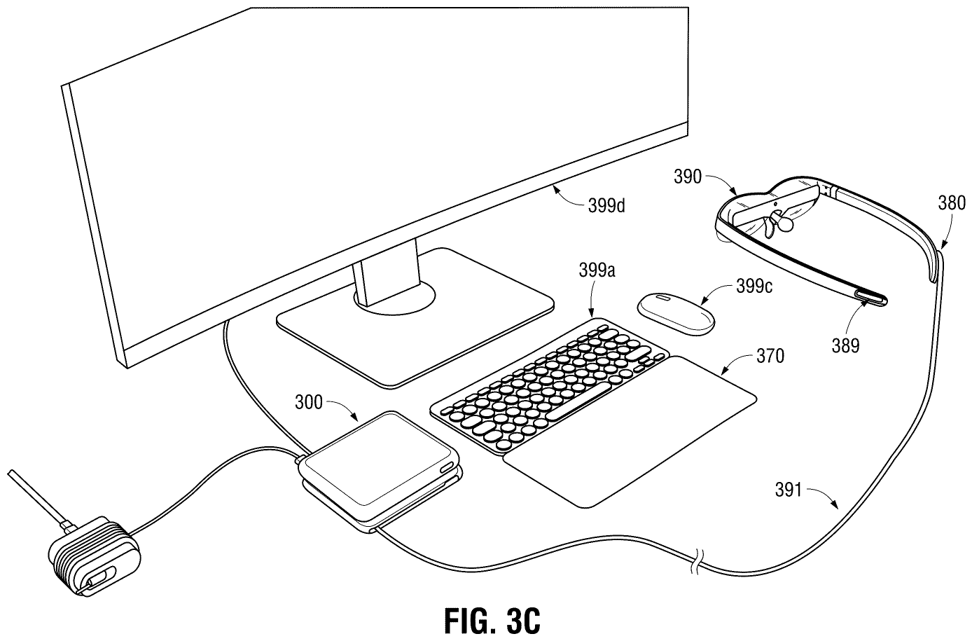

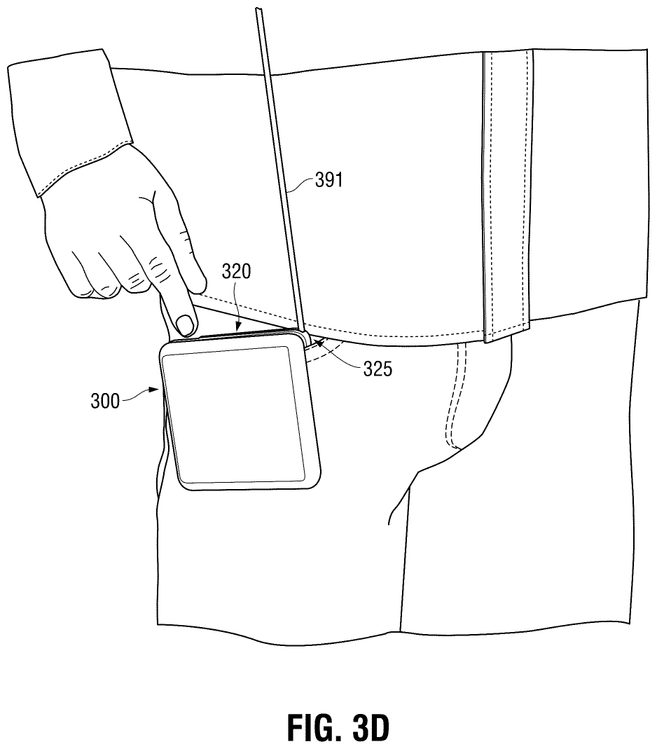

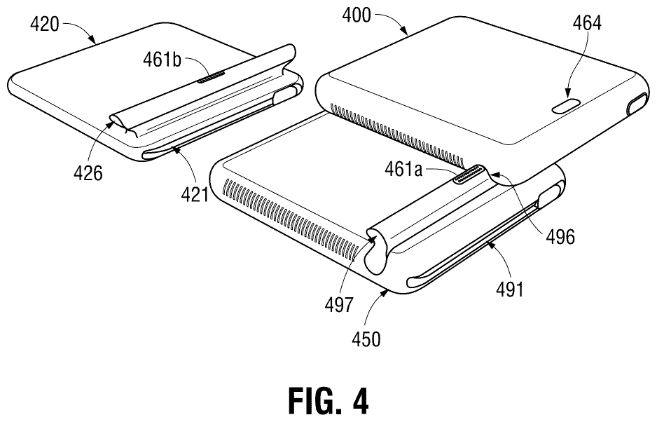

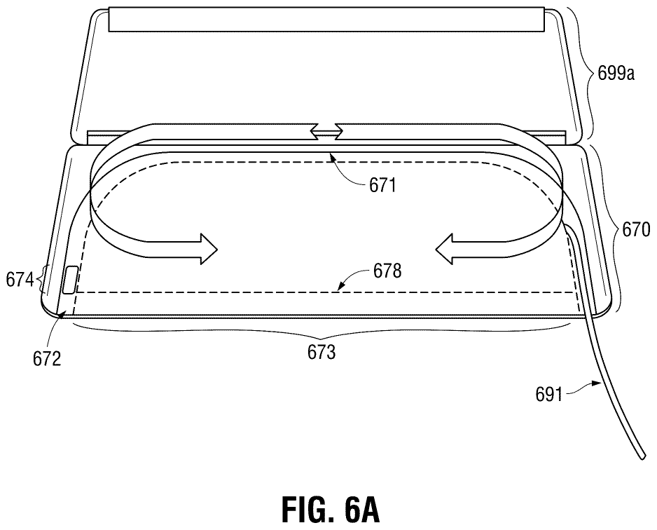

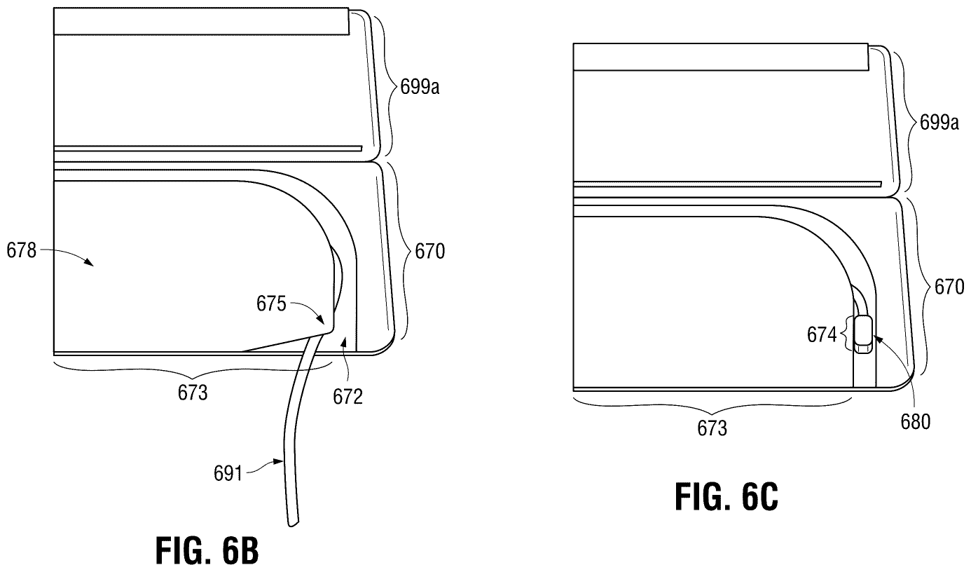

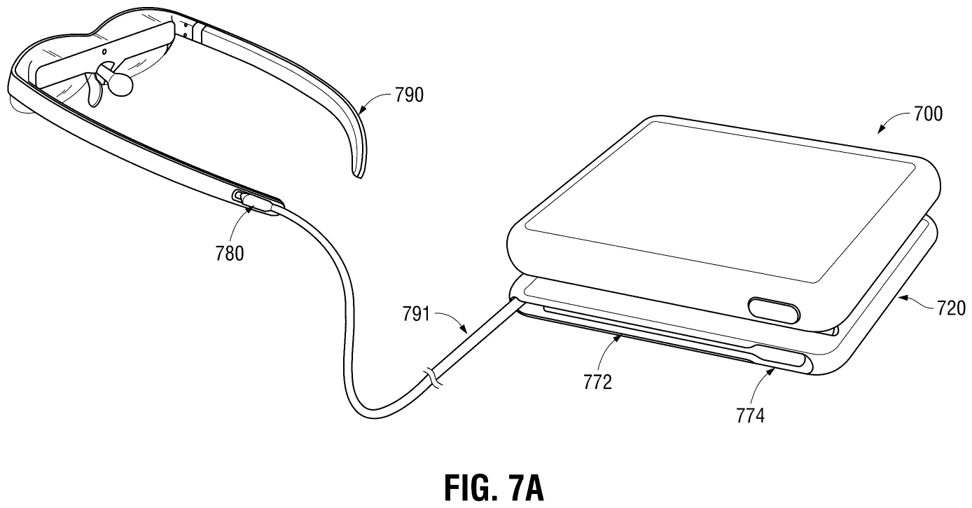

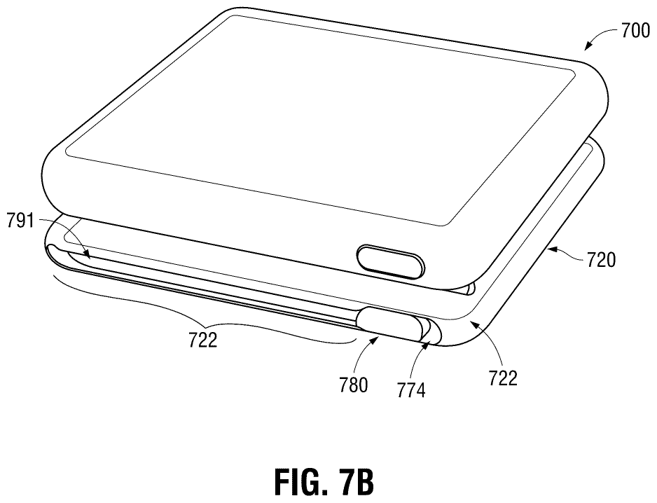

FIG. 3A is a graphical diagram illustrating an augmented reality/virtual reality (AR/VR) control modular computing device docking station 350 operably coupled to AR/VR glasses 390 and to an AR/VR control modular computing device 300 for desktop use in a user workspace according to an embodiment of the present disclosure. The AR/VR) control modular computing device docking station 350 is operably coupled to the AR/VR control modular computing device 300 providing supplemental hardware processing resources for control of AR/VR glasses display projector electronics 311 in the AR/VR glasses 390 by the AR/VR control modular computing device 300 through the AR/VR control modular computing device docking station 350 according to an embodiment of the present disclosure. An ecosystem of devices in the user workspace are described herein, which include AR/VR glasses 390, a touch drawing pad, digital display device, keyboard, touchpad, mouse, or others (e.g., as described below with respect to FIGS. 3C, 6A, 6B, and 6C). In other embodiments, such as for mobile usage, an AR/VR glasses mobile clip device is operatively coupled to the AR/VR glasses 390 (e.g., as described below with respect to FIGS. 4, 7A, and 7B) and an AR/VR control modular computing device 300. The AR/VR control modular computing device 300 is multifunctional in that it operates to generate and orchestrate the display of digital content within the AR/VR glasses 390 as well as for operating other computing functions for a user with I/O devices in a physical desktop user space such as a standalone digital display device, keyboard, touch drawing pad, mouse, dial or other I/O peripheral device for execution of machine readable code instructions of software or firmware in embodiments herein. This operation in the physical desktop user workspace may be augmented and coordinated with operable coupling of the AR/VR control modular computing device 300 with the AR/VR control modular computing device docking station 350 in embodiments herein. The AR/VR control modular computing device 300 may operatively couple with the touch drawing pad (not shown), the AR/VR glasses mobile clip device (not shown) for mobile use, or with an AR/VR control modular computing device docking station 350 for stationary or desktop use via an AR/VR control modular computing device secure connection port between a reciprocal secure mating channel on one side and a secure mating rail on the other side. The AR/VR control modular computing device docking station 350 may provide augmented hardware processing resources, additional ports, additional power supply capabilities, thermal cooling for the AR/VR control modular computing device 300, coordination with one or more I/O devices in the user workspace, and other capabilities expanded for the AR/VR control modular computing device 300 during stationary or desktop use in embodiments herein.

The AR/VR glasses 390 in an embodiment may be operatively coupled to the AR/VR control modular computing device docking station 350, via a AR/VR glasses data and power transfer cord 391 (e.g., Universal Serial Bus (USB)-C cord) having a universal and magnetic detachable cord connector 380. The universal and magnetic detachable cord connector 380 may operatively and communicatively couple the AR/VR glasses data and power transfer cord 391 to a receiving magnetic glasses power and data port on a temple or arm 313 of the AR/VR glasses, such as the left temple end of the AR/VR glasses 390 as shown in FIG. 3A. It is contemplated that the magnetic glasses power and data port may be located on either or both temples 313 of the AR/VR glasses 390 in various embodiments.

According to embodiments herein, the AR/VR control modular computing device docking station 350 may further be operatively coupled to the AR/VR control modular computing device 300 via an AR/VR control modular computing device secure connection port engaged through slidable attachment and detachment within a reciprocal secure mating channel the AR/VR control modular computing device 300 and a secure mating rail of the AR/VR control modular computing device docking station 350. The AR/VR control modular computing device docking station 350 in an embodiment may also include augmented hardware processing resources such as a graphics processing unit (GPU), neural processing unit (NPU), or application processing unit (APU) as described in example embodiment herein. The AR/VR control modular computing device docking station 350 in an embodiment may also be operatively coupled, via communication ports such as USB ports 392 (e.g., USB 3.0, USB-C), to one or more external input/output devices or one or more external augmented hardware processor devices, such as an external graphics processing unit (GPU), an external neural processing unit (NPU), or an external accelerated processing unit (APU), for example. This may allow the AR/VR control modular computing device 300 in an embodiment to leverage additional processing power of the AR/VR control modular computing device docking station 350 or of these external augmented hardware processor devices to maximize performance of the AR/VR glasses 390 when in use.

The AR/VR control modular computing device 300 in an embodiment may draw power via the AR/VR control modular computing device secure connector port engaged by mating with the AR/VR control modular computing device docking station 350, or further by application of DC voltage via the direct power port 398. The AR/VR control modular computing device 300 in an embodiment may transfer power and data to a touch drawing pad (not shown) through operative connection via the port 398. The AR/VR glasses 390 in an embodiment may be powered directly via the AR/VR glasses data and power transfer cord 391 and the universal and magnetic detachable cord connector 380 operatively coupled with the magnetic glasses power and data port from the AR/VR control modular computing device docking station 350 or from the AR/VR glasses mobile clip device described below with respect to FIGS. 4, 7A, and 7B.

FIG. 3B is a graphical diagram illustrating an augmented reality/virtual reality (AR/VR) control modular computing device docking station 350 operably coupled to AR/VR glasses 390 and to an AR/VR control modular computing device 300 in a user workspace ecosystem according to an embodiment of the present disclosure. The AR/VR control modular computing device docking station 350 is operably coupled to the AR/VR control modular computing device 300 for control of the AR/VR glasses 390 with external augmented hardware processor devices 345 available and operably coupled to the AR/VR control modular computing device docking station 350. The AR/VR control modular computing device docking station 350 is operably coupled to the AR/VR glasses 390 via an AR/VR glasses data and power transfer cord 391 and the universal and magnetic detachable cord connector 380 operatively coupled with a magnetic glasses power and data port on a temple of the AR/VR glasses 390 from the AR/VR control modular computing device docking station 350.

As described herein, using AR/VR glasses 390 allows users to organize a virtual workspace in the space around themselves, projected on top of the real world, which may include other I/O peripheral devices 399a, 399b. Interactions in this physical user workspace may use familiar peripherals such as a keyboard 399a, touchpad 399b, a mouse, a dial or other wired or wireless peripheral I/O devices for easy adoption and supporting existing applications executing on the AR/VR control modular computing device 300 and with support of the AR/VR control modular computing device docking station 350 in embodiments herein. The AR/VR control modular computing device docking station 350 in an embodiment may be wirelessly connected to one or more external input/output devices, such as wireless keyboard 399a and wireless touchpad 399b, for example, in an embodiment. This may allow the user to interact with these wireless input/output devices 399a and 399b to, for example, input keyboard strokes that may appear as text displayed within the AR/VR glasses 390 display or on a standalone digital display device (not shown). The touchpad 399b, for example, may allow the user to move a cursor within the AR/VR glasses 390 display as well as on any available standalone digital display that may be present in an embodiment.

The AR/VR control modular computing device docking station 350 in an embodiment may also be operatively coupled, via communication ports such as USB ports (e.g., 392 of FIG. 3A), to one or more external augmented hardware processor devices 345, which may include an external GPU, an external NPU, or an external APU, for example, to augment available hardware processing resources. This may allow the AR/VR control modular computing device 300 in an embodiment to leverage additional processing power of these external augmented hardware processor devices 345 to maximize performance of the AR/VR glasses 390 when in use. The AR/VR control modular computing device docking station 350 in an embodiment may draw power via the AC power adapter 350, which may be plugged into a wall outlet, for example.

FIG. 3C is a graphical diagram illustrating an augmented reality/virtual reality (AR/VR) control modular computing device docking station 350 operably coupled to AR/VR glasses 390 and to an AR/VR control modular computing device 300 in a desktop user workspace environment according to embodiments of the present disclosure. The AR/VR control modular computing device docking station 350 is operably coupled to the AR/VR control modular computing device 300 for control of the AR/VR glasses 399 and one or more input/output devices, including a touch drawing pad 370, a keyboard 399a, a mouse 399c, a digital display device 399d or other I/O devices within the user workspace. The touch drawing pad 370 may include an incorporated AR/VR glasses connector cord 391 operably coupled to the AR/VR glasses 390 via a universal and magnetic detachable cord connector 380. The universal and magnetic detachable cord connector 380 may be operatively and communicatively coupled by the AR/VR glasses data and power transfer cord 391 to a receiving magnetic glasses power and data port 389 on a temple of the AR/VR glasses, such as the right temple end of the AR/VR glasses as shown in FIG. 3A. It is contemplated that the magnetic glasses power and data port 389 may be located on either or both temples of the AR/VR glasses 390 in various embodiments.

The AR/VR control modular computing device docking station 350 augments hardware processing resources of the AR/VR control modular computing device 300 and provides additional ports, power resources, thermal cooling, and coordination of peripheral I/O devices 399a, 399c, 399d or 370 according to an embodiment of the present disclosure. As described herein, using AR/VR glasses 390 allows users to organize a virtual workspace in the space around themselves, projected on top of the real world, which may include other peripheral devices. Interactions in this physical user workspace use familiar peripherals such as a digital display device 399d, keyboard 399a, touch drawing pad 370, or a mouse 399c, for easy adoption and supporting existing software or firmware applications executing on the AR/VR control modular computing device 300 and with support of the AR/VR control modular computing device docking station 350. The AR/VR control modular computing device docking station 350 in an embodiment may be operatively coupled, wirelessly or via communication ports such as USB ports (e.g., 392 of FIG. 3A), to one or more external input/output devices, such as digital display device 399d, keyboard 399b, touch drawing pad 370, or mouse 399c, for example, in an embodiment. This may allow the user to interact with these wired input/output devices 370, 399c, 399a, and 399d to, for example, view augmented reality interactive icons surrounding the traditional display of content via the digital display 399d. The mouse 399c, for example, may allow the user to move a cursor within the AR/VR glasses 390 display, or within the digital display device 399d content in an embodiment. Keyboard 399a may provide input yielding characters displayed via the digital display device 399d or AR/VR glasses 390. In a further embodiment, the touch drawing pad 370 may also include a power and data transfer cord for attachment to the AR/VR control modular computing device docking station 350 or through another modular peripheral I/O device such as a keyboard 399a.

FIG. 3D is a graphical diagram illustrating an augmented reality/virtual reality (AR/VR) glasses mobile clip device 320 operably coupled to AR/VR glasses via an AR/VR power and data transfer cord 391 and to an AR/VR control modular computing device 300 for secure carrying of the AR/VR control modular computing device 300 during mobile use of the AR/VR glasses according to an embodiment of the present disclosure. As computing processing capabilities grow, so too does a need for more room to display content for user interaction, such as across a plurality of digital display devices or in combination with augmented reality or virtual reality (AR/VR) glasses that can further display holographic projected images of digital content. In some embodiments, such as mobile usage of the AR/VR control modular computing device 300, digital display devices may be replaced with AR/VR glasses. This enables users to be flexible to work in different locales, such as within the office, the home, public spaces, or on the move.

Embodiments of the present disclosure allow for such portability and security by providing an ecosystem of devices that include AR/VR glasses, an AR/VR glasses mobile clip device 320 for mobile use of the AR/VR glasses with augmented hardware processing support by an AR/VR control modular computing device 300 for generating and orchestrating the display of digital content within the AR/VR glasses. In the shown embodiment of FIG. 3D, the AR/VR glasses are not shown but are understood to be coupled via a retractable and magnetically securable cord 391 having a universal magnetic and detachable cord connector (not show). Further, the AR/VR glasses mobile clip device 320 may include the retractable and magnetically securable cord 391 retractable within the housing of the AR/VR glasses mobile clip device 320 for connecting the AR/VR glasses to the AR/VR glasses mobile clip device 320. The AR/VR glasses, as described in embodiments herein, include a magnetic glasses power and data port that may be located on either or both temples of the AR/VR glasses 390 for attachment and detachment of the retractable and magnetically securable cord 391 from the AR/VR glasses mobile clip device 320 via the universal magnetic and detachable cord connector. Further, the AR/VR glasses mobile clip device 320 includes a secure mating rail on its housing with a secure connector pin mount for sliding engagement or disengagement with a secure mating channel formed into the housing of the AR/VR control modular computing device 300. The housing of the AR/MR glasses mobile clip device 320 may be formed to have a clip structure when securely and operatively coupled to the AR/MR control modular computing device 300 such that the AR/MR glasses mobile clip device 320 and operatively coupled to the AR/MR control modular computing device 300 may be worn by a user, such as in a pocket 325 as shown. The AR/VR glasses mobile clip device 320 serves several functions including housing the retracting mechanism of the retractable and magnetically securable cord 391, providing connectivity ports in some embodiments, but also serving as a convenient physical clip for the AR/VR control modular computing device 300 such that it may be wearable or easily hung or placed in flexible locations within a physical user workspace environment. For example, the AR/VR glasses mobile clip device 320 operatively coupled to the AR/VR control modular computing device 300 in an embodiment may then be held in a user's pocket 325, for secure movement of the AR/VR control modular computing device 300 as the user walks.

FIG. 4 is a graphical diagram illustrating an augmented reality/virtual reality (AR/VR) control modular computing device 400 for forming a secure physical connection and a secure data transfer connection with either an AR/VR control modular computing device docking station 450 with augmented computing capabilities or an AR/VR glasses mobile clip device 420 for mobile function, via insertion of a secure mating rail within a secure mating channel, according to an embodiment of the present disclosure. As described herein, the AR/VR control modular computing device 450 in an embodiment may include an AR/VR control modular computing device secure connector within its housing for slidable attachment and detachment of the AR/VR glasses mobile clip device 420 or the AR/VR control modular computing device docking station 450 to the AR/VR control modular computing device 400 via secure mating channel 496.

An AR/VR control modular computing device 400 in an embodiment may be disconnected from any other modular devices, clips 420, or docking stations 450 with added computing and port capabilities via an AR/VR control modular computing device secure connector port within a secure mating channel 496 of the AR/VR control modular computing device 400, as shown in FIG. 4. As described herein, the AR/VR control modular computing device 400 in an embodiment may incorporate a secure mating channel 496 for insertion of a secure mating rail 426 or 497 and electrical coupling via a AR/VR control modular computing device secure connector port within the housing of the AR/VR control modular computing device 400 and extendable into the secure mating channel 496 that is actuated by a release button 464. A secure connector pin mount 461b is incorporated within the housing of the AR/VR glasses mobile clip device 420 or a secure connector pin mount 461a within the housing of the AR/VR control modular computing device docking station 450, respectively, to receive the AR/VR control modular computing device secure connector port that is actuated by a release button 464 for electrical coupling or secure physical operative coupling. The secure connector pin mount 461b or the secure connector pin mount 461a are formed into the secure mating rails 426 or 497 of the housing of the AR/VR glasses mobile clip device 420 or the housing of the AR/VR control modular computing device docking station 450 respectively.

In order to mate the AR/VR control modular computing device 400 to either an AR/VR control modular computing device docking station 450 or an AR/VR glasses mobile clip device 420, the user in an embodiment may press down on an AR/VR control modular computing device docking release button 464. This may push a flexible hinge an AR/VR control modular computing device secure connector port downward toward pivot pins of a secure connector pin mount 461a or 461b within the secure mating channel 496, to facilitate securing the secure mating rail 497 or 426 within the secure mating channel 496 after sliding the secure mating rail 497 or 426 into the secure mating channel 496. The secure mating channel 496 envelopes and securely and operatively couples to the secure mating rail 497 as it slides horizontally into the secure mating channel 496 in embodiments herein. When wishing to change locations when the AR/VR control modular computing device 400 are currently mated to either an AR/VR control modular computing device docking station 450 or an AR/VR glasses mobile clip device 420, the user may press down on the docking release button 464 housed within the AR/VR control modular computing device 400 and slide the AR/VR control modular computing device 400 away from the currently mated AR/VR control modular computing device docking station 450 or currently mated AR/VR glasses mobile clip device 420, in various embodiments. The AR/VR control modular computing device docking release button 464 with flexible hinge may be spring tensioned such that the AR/VR control modular computing device docking release button 464 has an up position and a down position where the AR/VR control modular computing device secure connector port is engaged with a secure connector pin mount 461a or 461b.

Upon pressing the release button 464 to an down position during mating, the secure mating channel 496 of the AR/VR control modular computing device 400 in an embodiment may continue to slide with respect to secure mating rail 497 or 426, until the secure mating rail 497 or 426 with the secure connector pin mount 461a or 461b, respectively, aligns with a AR/VR control modular computing device secure connector port within the secure mating channel 496. This alignment may allow springs to push a secure connector pin port housing of the AR/VR control modular computing device secure connector port at least partially into a port receiving channel housing the secure connector pin mount 461a or 461b. Insertion or partial insertion of the secure connector pin port housing within the port receiving channel in an embodiment which may inhibit further sliding movement between the secure mating channel 496 and the secure mating rail 497 or 426. In other words, the user may insert the secure mating rail 497 or 426 into the secure mating channel 496 of the AR/VR control modular computing device 400 until the secure connector pin port housing of the AR/VR control modular computing device secure connector port in the secure mating channel 496 drops into place within the port receiving channel housing of the secure connector pin mount 461a or 461b in the secure mating rail 426 or 497. This holds the position of the AR/VR control modular computing device 400 with respect to either the AR/VR glasses mobile clip device 420 or the AR/VR control modular computing device docking station 450, respectively. At this point, the AR/VR control modular computing device 400 is electrically coupled or physically operatively coupled with the AR/VR glasses mobile clip device 420 or the AR/VR control modular computing device docking station 450. In some embodiments, pressing the release button 464 to an up position electrically and physically disengages the AR/VR control modular computing device 400 from the AR/VR glasses mobile clip device 420 or the AR/VR control modular computing device docking station 450 for sliding removal.

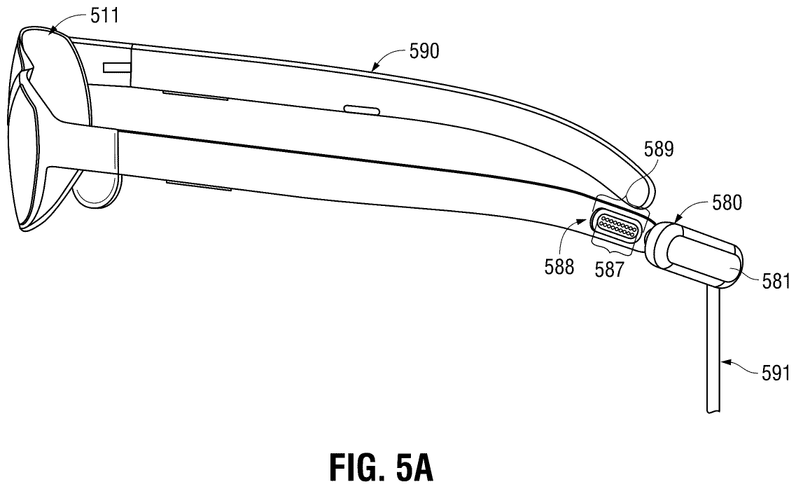

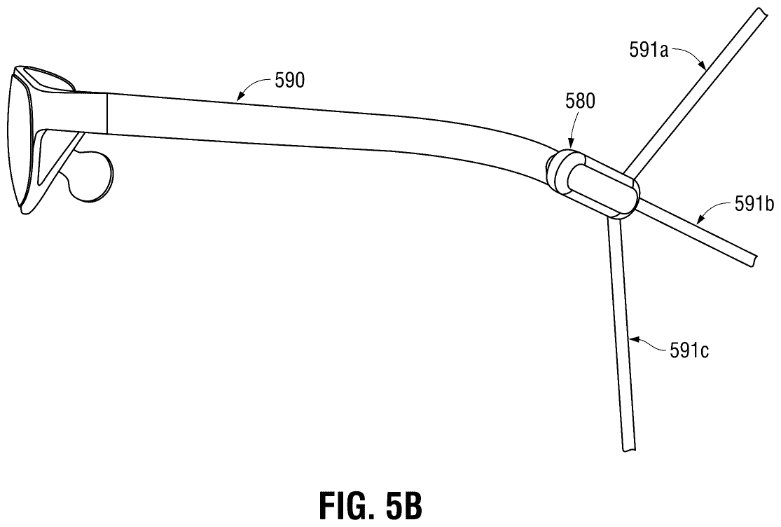

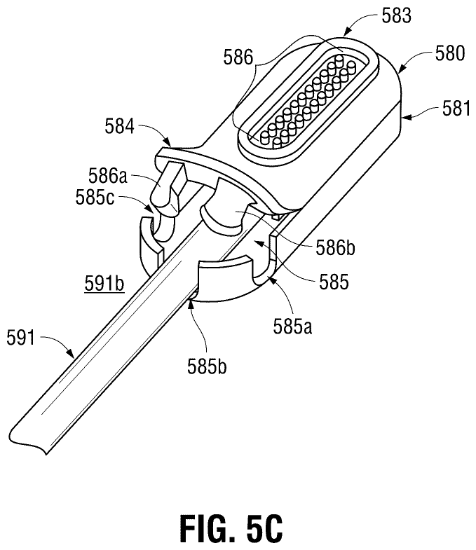

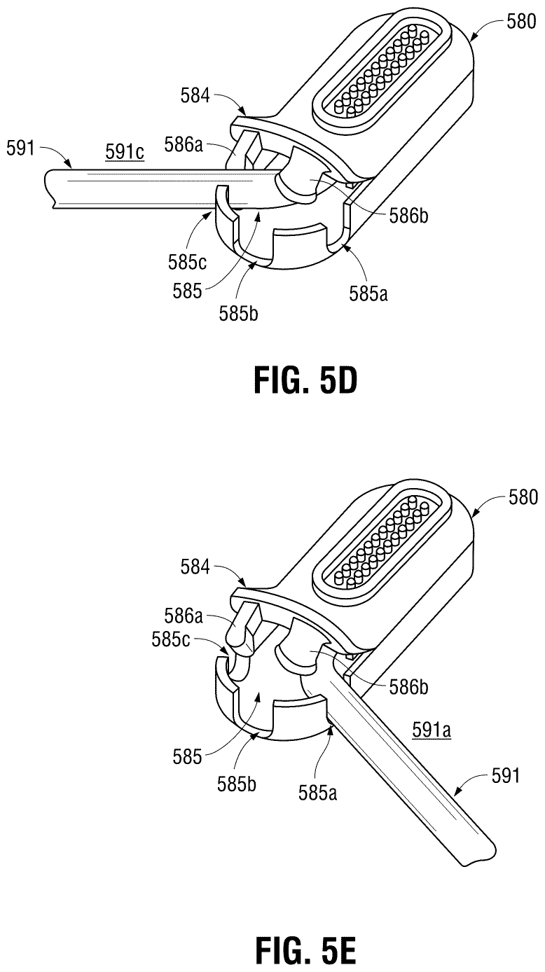

FIG. 5A is a graphical diagram illustrating augmented reality/virtual reality (AR/VR) glasses 590 having a glasses power and data port 589 for operative coupling with a magnetic and detachable cord connector 580 to form a wired connection to the AR/VR glasses 590 from a touch drawing pad, an AR/VR mobile clip device, or an AR/VR control modular computing device docking station according to an embodiment of the present disclosure. The glasses power and data port 589 operatively couples with a magnetic and detachable cord connector 580 via a magnetic stay 588 around a perimeter of the glasses power and data port 589 that magnetically couples to a magnetic stay on the magnetic and detachable cord connector 580 according to an embodiment of the present disclosure. As described herein, the ecosystem of devices described provides for a retractable AR/VR power and data transfer cord 591 for operative connection between the AR/VR glasses 590 and the touch drawing pad (not shown), AR/VR glasses mobile clip (not shown), or AR/VR control modular computing device docking station (not shown). Such a retractable AR/VR power and data transfer cord 591 in an embodiment may therefore have a variable length exposed from a retractable spooling mechanism which may be adjusted by user retraction or withdrawal of the retractable AR/VR power and data transfer cord from a cord housing within one of these operably coupled devices. Further, each of these retractable AR/VR power and data transfer cords 591 may have a universal magnetic and detachable cord connector 580, each of which may be used to detachably and magnetically connect to a AR/VR power and data port 589 housed in one or both temples of the AR/VR glasses 590 in embodiments herein.

The user in an embodiment may place a magnetic stay on the housing 581 of the universal magnetic and detachable cord connector 580 onto a magnetic stay 588 of the glasses power and data port 589 housed within an temple of the AR/VR glasses 590, such that pin contacts in the magnetic and detachable cord connector 580 come into electrically conductive contact with pin contact pads 587 in the glasses power and data port 589. In an embodiment, the user may also detach the magnetic stay on the housing 581 of the magnetic and detachable cord connector 580 from the magnetic stay 588 of glasses power and data port 589 housed within a temple of AR/VR glasses 590, such that the pin contacts in the universal magnetic and detachable cord connector 580 move out of electrically conductive contact with the pin contact pads 587 in the glasses power and data port 589. In embodiments herein, the glasses power and data port may be formed at or near the temple tip of either or both the left or right temple of the AR/VR glasses 590 for operatively coupling video data, AR/VR glasses location data, and power from the universal magnetic and detachable cord connector 580 of the AR/VR power and data transfer cord 591 to display projector electronics 511 of the AR/VR glasses. The magnetic stay on the housing 581 of the universal magnetic and detachable cord connector 580 may easily detach, in embodiments herein, from the magnetic stay 588 in a case where the user inadvertently walks away from the workspace, in order to avoid pulling the operatively connected touch drawing pad, AR/VR glasses mobile clip device, or AR/VR control modular computing device docking station off of a desk for example.

FIG. 5B is a graphical diagram illustrating augmented reality/virtual reality (AR/VR) glasses 590 having a glasses power and data port for operative coupling with a universal magnetic and detachable cord connector 580 for a wired connection that may be easily detached to avoid inadvertent movement of an operatively coupled touch drawing pad, AR/VR mobile clip device, or AR/VR control modular computing device docking station upon user movement around a user workspace according to an embodiment of the present disclosure. In FIG. 5B, the universal magnetic and detachable cord connector 580 of the AR/VR power and data transfer cord 591 is illustrated as magnetically and operatively coupled to the glasses power and data port on a temple of the AR/VR glasses 590 according to an embodiment herein. In one embodiment, the glasses power and data port may be formed at or near the temple tip of either or both the left or right temple of the AR/VR glasses 590 for operatively coupling video data, AR/VR glasses location data, and power from the universal magnetic and detachable cord connector 580 of the AR/VR power and data transfer cord 591 to display projector electronics 511 of the AR/VR glasses. As described herein, and in greater detail below with respect to FIGS. 5C, 5D, and 5E, the universal magnetic and detachable cord connector 580 may include a plurality of cord positioning channels in the cord connector housing that allow the user to place the AR/VR power and data transfer cord 591 in one of a plurality of positions, including a straight configuration 591b, an upward configuration 591a, and a downward configuration 591c that define the angle at which the AR/VR power and data transfer cord 591 drapes behind the user when operatively coupled at the opposite end to a touch drawing pad, an AR/VR mobile clip device, or an AR/VR control modular computing device docking station.

FIG. 5C is a graphical diagram illustrating a universal magnetic and detachable cord connector 580 with adjustable placement of an augmented reality/virtual reality (AR/VR) glasses power and data cord 590 according to an embodiment of the present disclosure. The universal magnetic and detachable cord connector 580 may include a housing 591 with a cord positioning cavity 585 formed therein at the terminus of the AR/VR power and data transfer cord 591 having a plurality of positioning channels 585a, 585b, and 585c. The AR/VR power and data transfer cord 591 may be arranged in a straight configuration 591b, as shown, within the cord positioning channel 585b in a magnetic and detachable cord connector housing 581. Cord positioning channel 585b position the AR/VR power and data transfer cord 591 to leave the cord positioning cavity 585 and the temple end of the AR/VR glasses 590 in a straight line with respect to the temple of the AR/VR glasses 590 according to an embodiment of the present disclosure. In various embodiments in which the user has chosen to use a AR/VR power and data transfer cord 591 from a touch drawing pad, an AR/VR glasses mobile clip device, or an AR/VR control modular computing device docking station, the user may lift a cord directional adjustment jacket 584 in the magnetic and detachable cord connector 580 and shift the AR/VR power and data transfer cord 591 to a user-preferred one of a plurality of cord positioning channels 585a, 585b, or 585c in a sidewall of the cord positioning cavity 585 in the cord connector housing 581. For example, the AR/VR power and data transfer cord 591 in an embodiment may be placed in the cord positioning channel 585b to achieve a straight configuration 591b with respect to the AR/VR glasses (e.g., 591b of FIG. 5B). The user may close the cord directional adjustment jacket 584 in the magnetic and detachable cord connector 580 to engage adjustment jacket teeth 586a and 586b to lock the AR/VR power and data transfer cord 591 into a user-preferred cord positioning channel 585a, 585b, or 585c in cord positioning cavity 585 of the cord connector housing 581 in an embodiment. In an embodiment, the adjustment jacket teeth 586a and 586b may snap fit into the sides of the cord positioning cavity 585 to lock the cord directional adjustment jacket 584, but the cord directional adjustment jacket 584 may still be opened to select a different configuration via the other cord positioning channels 585a, 585b, or 585c. The user, in an embodiment, place a magnetic stay 583 of the universal magnetic and detachable cord connector 580 onto a magnetic stay (e.g., 588 of FIG. 5A) of the glasses power and data port (e.g., 589 of FIG. 5A) housed within a temple end of the AR/VR glasses (e.g., 590 of FIG. 5A), such that pin contacts 586 in the magnetic and detachable cord connector 580 come into electrically conductive contact with pin contact pads (e.g., 587 of FIG. 5A) in the glasses power and data port (e.g., 589 of FIG. 5A) in embodiments herein.

FIG. 5D is a graphical diagram illustrating placement of an augmented reality/virtual reality (AR/VR) glasses data and power cord 591 in a down configuration 591c within a cord positioning channel 585c in a magnetic and detachable cord connector housing 581 according to an embodiment of the present disclosure. The universal magnetic and detachable cord connector 580 may include a magnetic and detachable cord connector housing 581 with a cord positioning cavity 585 having plural cord positioning channels 585a, 585b, and 585 formed in a sidewall of the cord positioning cavity. In an embodiment, the AR/VR power and data transfer cord 591 ends in the cord positioning cavity and may be adjusted therein to position the AR/VR power and data transfer cord 591 to leave the cord positioning cavity 585 and the temple end of AR/VR glasses at a downward angle configuration 591c with respect to the temple of the AR/VR glasses according to an embodiment of the present disclosure. In the shown example embodiment, the AR/VR power and data transfer cord 591 may be placed in the cord positioning channel 585c to achieve a down configuration 591c with respect to the temple of the AR/VR glasses (e.g., 591c of FIG. 5B). FIG. 5D also illustrates the adjustment jacket teeth 586a and 586b of the cord directional adjustment jacket 584 may snap fit into the sides of the cord positioning cavity 585 to lock the cord directional adjustment jacket 584 and hold the AR/VR power and data transfer cord 591 in the cord positioning channel 585c in an embodiment. However, the cord directional adjustment jacket 584 may still be opened, as shown, to select a different configuration via the other cord positioning channels 585a, 585b, or 585c in embodiments herein.

FIG. 5E is a graphical diagram illustrating placement of an augmented reality/virtual reality (AR/VR) glasses data and power cord 591 in an up configuration 591a within a cord positioning channel 585a in a magnetic and detachable cord connector housing 581 according to an embodiment of the present disclosure. The universal magnetic and detachable cord connector 580 may include a magnetic and detachable cord connector housing 581 with a cord positioning cavity 585 having plural cord positioning channels 585a, 585b, and 585 formed in a sidewall of the cord positioning cavity. In an embodiment, the AR/VR power and data transfer cord 591 ends in the cord positioning cavity and may be adjusted therein to position the AR/VR power and data transfer cord 591 to leave the cord positioning cavity 585 and the temple end of AR/VR glasses at a upward angle configuration 591a with respect to the temple of the AR/VR glasses according to an embodiment of the present disclosure. In the shown example embodiment, the AR/VR power and data transfer cord 591 may be placed in the cord positioning channel 585a to achieve a down configuration 591a with respect to the temple of the AR/VR glasses (e.g., 591a of FIG. 5B). FIG. 5E also illustrates the adjustment jacket teeth 586a and 586b of the cord directional adjustment jacket 584 may snap fit into the sides of the cord positioning cavity 585 to lock the cord directional adjustment jacket 584 and hold the AR/VR power and data transfer cord 591 in the cord positioning channel 585a in an embodiment. However, the cord directional adjustment jacket 584 may still be opened, as shown, to select a different configuration via the other cord positioning channels 585a, 585b, or 585c in embodiments herein.

FIG. 6A is a graphical diagram illustrating a bottom view of a touch drawing pad housing that includes cord channels for storage of a cord for connecting to augmented reality/virtual reality (AR/VR) glasses that may be oriented to exit either the right or left side of the touch drawing pad 670 to avoid interference with drawing on the touch drawing pad during use according to an embodiment of the present disclosure. As described herein, embodiments of the present disclosure provide for a AR/VR power and data transfer cord 691 for operative coupling between the AR/VR glasses (not shown) and the touch drawing pad 670. Such an AR/VR power and data transfer cord 691 in an embodiment may have a variable length which may be adjusted by user wrapping the AR/VR power and data transfer cord 691 around a cord wind mount 678 as part of the underside of a cord housing 673 within the touch drawing pad 670. The AR/VR power and data transfer cord 691 may be operatively coupled to the keyboard 699a, via port 671, and to the AR/VR control modular computing device directly, or indirectly through the AR/VR control modular computing device docking station, via a USB-C connection with the keyboard 699a.

In an embodiment in which the user has operatively coupled the AR/VR control modular computing device to the touch drawing pad 670, the user may detach a magnetic and detachable cord connector (not shown, but described in greater detail below with respect to FIG. 6C) from a magnetic cradle 674 on the left or right side within a cord channel 672 inside the bottom housing 673 of the touch drawing pad 670. Cord channel 672 surrounds the cord wind mount 678 on either side of the bottom housing 673 of the touch drawing pad 670 to provide for an egress of the AR/VR power and data transfer cord 691 at any unwound length for operative coupling with AR/VR glasses according to embodiments herein. The user in an embodiment may unwind the touch drawing pad cord 691 from a cord wind mount 678 within the touch drawing pad housing 673, and orient the touch drawing pad cord 691 to either a left or right side (here, shown as coming from the user's left side once the touch drawing pad 670 is turned over into its operating position) of the cord wind mount 678 on the bottom surface of the touch drawing pad housing 673, to suit the user's preference and ease user movement about the workspace and access to the touch drawing pad 670 when placed right side up and operational. The right side up orientation of the touch drawing pad 670 and the keyboard 699a may be seen in FIG. 3C at touch drawing pad 370 and keyboard 399a respectively.

FIG. 6B is a graphical diagram illustrating a bottom view of a touch drawing pad bottom housing 673 that includes a cord winding mount 678 for storage of a AR/VR power and data transfer cord 691 for connecting to AR/VR glasses and a holder edge 675 for holding the AR/VR power and data transfer cord 691 at a desired length during use according to an embodiment of the present disclosure. In an embodiment in which the touch drawing pad 670 is operatively coupled to the AR/VR control modular computing device via the keyboard 699a and the user connects the AR/VR power and data transfer cord 691 with the AR/VR glasses, the user may wind the AR/VR power and data transfer cord 691 around cord wind mount 678 in the touch drawing pad housing 673 bottom surface such that a desired length of the AR/VR power and data transfer cord 691 for use as extended from a cord channel 672 on either the left or right in embodiments herein. The AR/VR power and data transfer cord 691 may be pulled into the holder edge 675 of the touch drawing pad bottom housing 673 to secure the desired length in embodiments herein.

FIG. 6C is a graphical diagram illustrating a bottom view of a touch drawing pad bottom housing 673 with a stored AR/VR power and data transfer cord 691 disconnected from augmented reality/virtual reality (AR/VR) glasses and having its magnetic and detachable cord connector 680 connected to a magnetic cradle 674 according to an embodiment of the present disclosure. In an embodiment in which the touch drawing pad 670 is operatively coupled to the AR/VR control modular computing device but the user disconnects the AR/VR power and data transfer cord 691 from the AR/VR glasses, the user may wind the AR/VR power and data transfer cord 691 around cord wind mount 678 in the touch drawing pad housing 673 bottom surface for storage. Upon winding the cord 691 around cord wind mount 698 in the touch drawing pad housing 673 bottom surface, the user may further place the universal magnetic and detachable cord connector 680 in the magnetic cradle 674 in the housing 673 for the touch drawing pad 670.

FIG. 7A is a graphical diagram illustrating an augmented reality/virtual reality (AR/VR) glasses mobile clip device 720 operably coupled to an AR/VR control modular computing device 700 and housing a retractable AR/VR power and data transfer cord 791 for operably connecting to AR/VR glasses 790 during mobile use of the AR/VR glasses 790 according to an embodiment of the present disclosure. As described herein, using AR/VR glasses 790 allows users to organize a virtual workspace in the space around themselves, projected on top of the real world. Interactions in this user workspace may further use familiar peripherals such as a keyboard, touchpad, and a mouse, for easy adoption and supporting existing applications. AR/VR glasses 790 further allow users to visualize their workspace in a format only viewable by the user themselves, allowing them to work or enjoy media such as a movie in privacy anywhere in a mobile usage mode.

Embodiments of the present disclosure allow for such portability and security by providing an ecosystem of devices that include AR/VR glasses 790, an AR/VR glasses mobile clip device 720 for mobile use of the AR/VR glasses 790, and an AR/VR control modular computing device 700 with secure operative coupling to the AR/VR glasses mobile clip device. The AR/VR control modular computing device 700 is a multi-function computing device for generating and orchestrating the display of digital content within the AR/VR glasses 790 and for conducting hardware and software processing with other peripheral devices regardless of whether AR/VR glasses 790 are engaged in various embodiments. Further, the AR/VR glasses mobile clip device 720 may include a retractable and magnetically securable AR/VR power and data transfer cord 791 having a universal magnetic and detachable cord connector 780 for operably coupling the AR/VR glasses 790 to the AR/VR glasses mobile clip device 720. The universal magnetic and detachable cord connector 780 may magnetically and operatively couple to a temple of the AR/VR glasses 790 with reciprocal magnetic mating functionality of a glasses power and data port 589 of FIGS. 5A and 5B.

The AR/VR glasses mobile clip device 720 includes a spring-loaded spool retracting mechanism within the housing of the AR/VR glasses mobile clip device 720 in embodiments herein such that AR/VR power and data transfer cord 791 is retractable into a cable channel 772 and into the housing of AR/VR glasses mobile clip device 720 in embodiments herein. Further, the AR/VR glasses mobile clip device 720 includes a magnetic cradle 774 for magnetically coupling the universal magnetic and detachable cord connector 780 when the AR/VR power and data transfer cord 791 is stored and not used with the AR/VR glasses 790 in embodiments.

The AR/VR glasses mobile clip device 720 also includes a secure connector pin mount as part of the secure mating rail (or secure mating channel), as shown in FIG. 4, for slidable attachment and detachment of the AR/VR glasses mobile clip device 720 to the AR/VR control modular computing device 700. In some embodiments, the AR/VR glasses mobile clip device 720 and the AR/VR control modular computing device 700 may be of similar width or length to provide a seamless form factor for ease of use and storage as well as for aesthetic purposes.

FIG. 7B is a graphical diagram illustrating an augmented reality/virtual reality (AR/VR) glasses mobile clip device 720 operably coupled to an AR/VR control modular computing device 700 and housing a retracted and magnetically secured AR/VR glasses power and data cable 791 with universal magnetic and detachable cord connector 780 in a stowed position when not operably connected to AR/VR glasses according to an embodiment of the present disclosure. The retractable AR/VR power and data transfer cord 791 may retract into a retractable AR/VR glasses mobile clip device housing 722 and a cord channel 772 therein within the AR/VR glasses mobile clip device 720 when the AR/VR glasses are disconnected. The outer portion of the retractable AR/VR power and data transfer cord housing 722 is shown with a cord channel 774 and magnetic cradle 774 along the edge of the AR/VR glasses mobile clip device 720, but it is contemplated that a retractable spooling device may wind the retractable AR/VR power and data transfer cord 791 within the housing of the AR/VR glasses mobile clip device 720 in embodiments herein with a cord channel 772 along any edge or any side of the housing 722 for the AR/VR glasses mobile clip device 720 in other embodiments. When disconnected from the AR/VR glasses 790, a universal magnetic and detachable cord connector 780 may magnetically latch to magnetic cradle 774 of the AR/VR glasses mobile clip device 720 within the cord channel 772 for ease of storage in other embodiments.

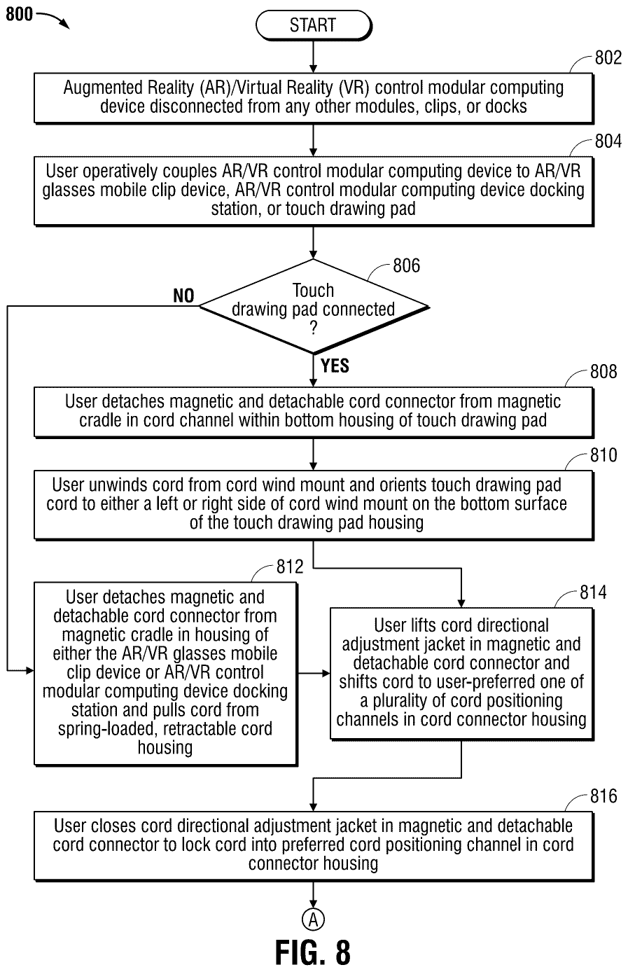

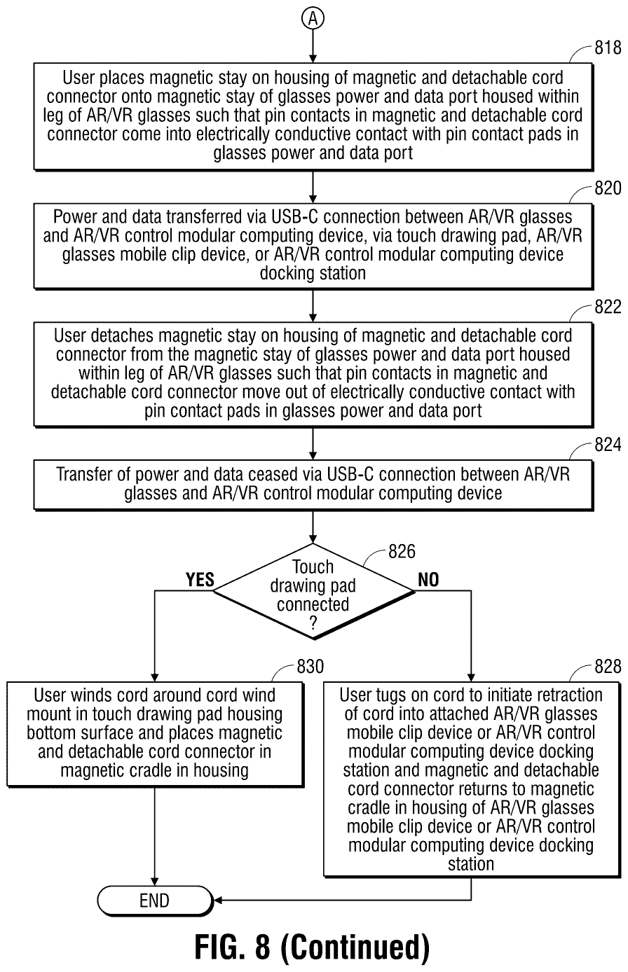

FIG. 8 is a flow diagram illustrating a method of connecting and disconnecting an augmented reality/virtual reality (AR/VR) control modular computing device with AR/VR glasses, via an AR/VR control modular computing device docking station, an AR/VR glasses mobile clip device, or a touch drawing pad using a magnetic and detachable cord connector that can be positioned in a plurality of orientations with respect to the AR/VR glasses according to an embodiment of the present disclosure. As described herein, using AR/VR glasses allows users to organize a virtual workspace in the space around themselves, projected on top of the real world and to visualize their workspace in a format only viewable by the user themselves, allowing them to work or enjoy media such as a movie in privacy anywhere. Embodiments of the present disclosure allow for such portability and security by providing an ecosystem of devices in which a multi-function AR/VR control modular computing device may be easily and efficiently swapped between a mobile usage with AR/VR glasses by a user or enhanced with additional computing NPU or GPU capabilities via engagement with an AR/VR control modular computing device docking station in embodiments herein. The AR/VR control modular computing device may further be operatively connected to a touch drawing pad and keyboard in a desktop user workspace either through direct Universal Serial Bus (USB) C connection, or through a USB-C connection between the touch drawing pad and an operatively coupled AR/VR control modular computing device docking station.

The ecosystem of devices for use with the multi-function AR/VR control modular computing device include AR/VR glasses, an AR/VR glasses mobile clip device for mobile use of the AR/VR glasses, and the AR/VR control modular computing device for generating and orchestrating the display of digital content within the AR/VR glasses. The ecosystem of devices also includes the multi-function AR/VR control modular computing device docking station with enhanced hardware computing resources, memory, and other components for use of the multi-function AR/VR control modular computing device with an assortment of desktop peripheral devices such as a standalone display device, physical keyboard, touch drawing pad, mouse, dial or other I/O devices for independent or coordinated operation with AR/VR glasses. The multi-function AR/VR control modular computing device docking station may provide additional operable connection to additional input/output devices, or external augmented hardware processor devices to increase productivity of the AR/VR control modular computing device.

At block 802, the AR/VR control modular computing device secure connector port within a secure mating channel of an AR/VR control modular computing may be in a disconnected state from any other modular docking station, AR/VR glasses mobile clip devices, or other modules or peripheral devices in an embodiment. As described herein, the housing of the AR/VR control modular computing device in an embodiment may incorporate an AR/VR control modular computing device secure connector port actuatable into a secure mating channel via a secure connector pin port. The secure mating channel formed in the housing of the AR/VR control modular computing device may slidingly engage with a secure mating rail incorporated within the housing of the AR/VR glasses mobile clip device or the AR/VR control modular computing device docking station slidingly inserted therein.

For example, in an embodiment described with respect to FIG. 4, an AR/VR control modular computing device 400 may be initially disconnected from any other modules, AR/VR glasses mobile clip devices 420, or AR/VR control modular computing device docking station 450. An AR/VR control modular computing device secure connector port within the housing of the AR/VR control modular computing device 400 and actuatable into a secure mating channel 496 of the AR/VR control modular computing device 400 may be disconnected as well. As described herein, the housing of the AR/VR control modular computing device 400 in an embodiment may incorporate a secure mating channel 496 for insertion of a secure mating rail 426 or 497, incorporated within the housing of the AR/VR glasses mobile clip device 420 or the AR/VR control modular computing device docking station 450, respectively.

The user in an embodiment at block 804 may operatively couple the AR/VR control modular computing device to the AR/VR glasses mobile clip device, AR/VR control modular computing device docking station, or a touch drawing pad. The AR/VR glasses mobile clip device or the multi-function AR/VR control modular computing device docking station may include a secure connector pin mount on a secure mating rail, or in a secure mating channel in alternative embodiments, for slidable attachment and detachment of the AR/VR glasses mobile clip device or the multi-function AR/VR control modular computing device docking station to the AR/VR control modular computing device. A complimentary AR/VR control modular computing device secure connector port to the secure connector pin mount may be formed within the housing of the AR/VR control modular computing device for actuation into the reciprocal secure mating channel (or on the secure mating rail) to provide for slidable attachment and detachment of an AR/VR control modular computing device docking station or to the AR/VR glasses mobile clip device in embodiments herein.

Such slidable attachment in various embodiments herein may push pin contacts within the secure connector pin mount of the AR/VR control modular computing device secure connector port into electrically conductive contact with pin ports within the secure connector pin port housing of the secure connector pin mount. This electrically conductive contact in an embodiment may complete a power or data transfer connection, such as a Universal Serial Bus (USB-C) connection, for example, between the AR/VR control modular computing device and the AR/VR glasses mobile clip device or AR/VR control modular computing device docking station. The AR/VR control modular computing device may further be operatively connected to a touch drawing pad either through direct Universal Serial Bus (USB) C connection, or through a USB-C connection between the touch drawing pad and an operatively coupled AR/VR control modular computing device docking station.

At block 806, it may be determined whether a touch drawing pad has additionally been operatively coupled to the AR/VR control modular computing device in an embodiment. As described herein, both the AR/VR control modular computing device docking station and the AR/VR glasses mobile clip device may provide a retractable AR/VR power and data transfer cord for wired connection to AR/VR glasses. Additionally, a touch drawing pad may also supply a separate AR/VR power and data transfer cord for wired connection to AR/VR glasses. If the user has operatively coupled the AR/VR control modular computing device to the touch drawing pad in an embodiment, the method may proceed to block 808 for wired connection between the AR/VR glasses and the touch drawing pad. If the user has not operatively coupled the AR/VR control modular computing device to the touch drawing pad, the method may proceed to block 812 for wired connection between the AR/VR glasses and the AR/VR control modular computing device docking station or the AR/VR glasses mobile clip device, which may have similar cord housing mechanisms for an AR/VR glasses power or data cord.

In an embodiment at block 808 in which the user has operatively coupled the AR/VR control modular computing device to the touch drawing pad, the user may detach a magnetic and detachable cord connector from a magnetic cradle within a cord channel inside the bottom housing of the touch drawing pad. For example, in embodiments described with respect to FIGS. 6A, 6B, and 6C, in which the user has operatively coupled the AR/VR control modular computing device to the touch drawing pad 670, the user may detach a magnetic and detachable cord connector 680 from a magnetic cradle 674 within a cord channel 672 inside the bottom housing 673 of the touch drawing pad 670.

At block 810, the user may unwind the touch drawing pad cord from the cord wind mount within the touch drawing pad housing, and orient the touch drawing pad cord to either a left or right side of the cord wind mount on the bottom surface of the touch drawing pad housing, to suit the user's preference and ease user movement about the workspace and access to the touch drawing pad when placed right side up and operational. For example, the user in an embodiment may unwind the touch drawing pad cord 691 from a cord wind mount within the touch drawing pad housing 673, and orient the touch drawing pad AR/VR power and data transfer cord 691 to either a left or right side of the cord wind mount on the bottom surface of the touch drawing pad housing 673, to suit the user's preference and ease user movement about the workspace and access to the touch drawing pad 670 when placed right side up and operational. The method may then proceed to block 814 for connection of the AR/VR power and data transfer cord to the AR/VR glasses. Flow may then proceed to block 814.

Returning to block 806, in which the user has not operatively coupled the AR/VR control modular computing device to the touch drawing pad, the method may proceed to block 812. At block 812, the user may detach the universal magnetic and detachable cord connector from the magnetic cradle in the housing of either the AR/VR glasses mobile clip device or the AR/VR control modular computing device docking station and pull the cord from a spring-loaded, retractable cord spool in a housing of the AR/VR glasses mobile clip device or the AR/VR control modular computing device docking station. For example, in embodiments described with respect to FIGS. 7A and 7B, the outer edge of the retractable AR/VR power and data transfer cord housing 722 includes a cord channel 772 and a magnetic cradle 774 shown along the edge of the AR/VR glasses mobile clip device 720, but it is contemplated that a retractable spooling device may wind the retractable AR/VR power and data transfer cord 791 within the housing of the AR/VR glasses mobile clip device 720 in embodiments herein with the cord channel 772 along the edge of the housing 722 for the AR/VR glasses mobile clip device 720. A similar system may be made available in some embodiments with an AR/VR control modular computing device docking station according to some embodiments herein. The method may proceed to block 814.

At block 814, in various embodiments in which the user has chosen to use an AR/VR power and data transfer cord from a touch drawing pad, an AR/VR glasses mobile clip device, or an AR/VR control modular computing device docking station, the user may lift a cord directional adjustment jacket in a housing of the universal magnetic and detachable cord connector and shift the AR/VR power and data transfer cord to a user-preferred one of a plurality of cord positioning channels in a cord positioning cavity of the cord connector housing. For example, in various embodiments described with respect to FIGS. 5A, 5b, 5C, 5D, and 5E, in which the user has chosen to use an AR/VR power and data transfer cord 591 from a touch drawing pad, an AR/VR glasses mobile clip device, or an AR/VR control modular computing device docking station, the user may lift a cord directional adjustment jacket 584 in the magnetic and detachable cord connector 580 and shift the AR/VR power and data transfer cord 591 to a user-preferred one of a plurality of cord positioning channels 585a, 585b, or 585c in the cord connector housing 581. More specifically, the AR/VR power and data transfer cord 591 in an embodiment may be placed in the cord positioning channel 585b to achieve a straight configuration 591b with respect to the AR/VR glasses 590. In another example embodiment, the AR/VR power and data transfer cord 591 may be placed in the cord positioning channel 585c to achieve a down configuration 591c with respect to the AR/VR glasses 590. In yet another example embodiment, the AR/VR power and data transfer cord 591 may be placed in the cord positioning channel 585a to achieve an upward configuration 591a with respect to the AR/VR glasses 590.

In an embodiment at block 816, the user may close the cord directional adjustment jacket in the cord connector housing of the universal magnetic and detachable cord connector to lock the AR/VR power and data transfer cord into a user-preferred cord positioning channel in the cord connector housing. For example, the user may close the cord directional adjustment jacket 584 in the magnetic and detachable cord connector 580 with a snap fit to lock the AR/VR power and data transfer cord 591 into a user-preferred cord positioning channel 585a, 585b, or 585c in walls of the cord position cavity 585 in the cord connector housing 581.

At block 818, the user in an embodiment may place a first magnetic stay on the housing of the universal magnetic and detachable cord connector onto a reciprocal magnetic stay of the glasses power and data port housed within either temple of the AR/VR glasses, such that pin contacts in the universal magnetic and detachable cord connector come into electrically conductive contact with pin contact pads in the glasses power and data port. For example, in embodiments of FIGS. 5A to 5E, the user in an embodiment may place a first magnetic stay 583 on the magnetic and detachable cord connector 580 onto a reciprocal magnetic stay 588 of the glasses power and data port 589 housed within a temple of the AR/VR glasses 590, such that pin contacts 586 in the universal magnetic and detachable cord connector 580 come into electrically conductive contact with pin contact pads 587 in the glasses power and data port 589.

In an embodiment at block 820, power and data may be transferred via a USB-C connection or other data and power connection between the AR/VR glasses and the AR/VR control modular computing device, via the touch drawing pad, the AR/VR glasses mobile clip device, or the AR/VR control modular computing device docking station using a respective AR/VR power and data transfer cord. The AR/VR control modular computing device may allow power transfer or transfer of data, via the power or data transfer connection formed by the electrically conductive contact with the pin contact pads in the glasses power and data port and the pin contacts in the universal magnetic and detachable cord connector. Such electrically conductive contact may form, for example, a USB-C connection between the AR/VR control modular computing device and AR/VR glasses, via the touch drawing pad, AR/VR glasses mobile clip device, or the AR/VR control modular computing device docking station.

For example, in an embodiment described with respect to FIG. 1, power and data may be transferred via a USB-C connection of a AR/VR power and data transfer cord 191a or 191b between the AR/VR glasses 190 and the AR/VR control modular computing device 100, via the touch drawing pad 170, the AR/VR glasses mobile clip device 120, or the AR/VR control modular computing device docking station 150. The AR/VR control modular computing device 100 may allow power transfer or transfer of data, via the power or data transfer connection formed by electrically conductive contact with pin contact pads in a glasses power and data port of the AR/VR glasses 190 and pin contacts in a universal magnetic and detachable cord connector 180 of the AR/VR power and data transfer cord 191a or 191b forming the power and data connection between the AR/VR glasses 190 and any of the touch drawing pad 170, the AR/VR mobile clip device 120, or the AR/VR control modular computing device docking station 150. Such electrically conductive contact may form, for example, a USB-C connection between the AR/VR control modular computing device 100 and the AR/VR glasses 190, via the touch drawing pad 170, AR/VR glasses mobile clip device 120, or the AR/VR control modular computing device docking station 150.

At block 822, the user in an embodiment may detach the magnetic stay on the housing of the universal magnetic and detachable cord connector from the magnetic stay of glasses power and data port housed within the temple arm of AR/VR glasses, such that the pin contacts in the magnetic and detachable cord connector move out of electrically conductive contact with the pin contact pads in the glasses power and data port. For example, in an embodiment described with respect to FIG. 5A, the user may detach the magnetic stay on the housing 581 of the universal magnetic and detachable cord connector 580 from the reciprocal magnetic stay 588 of glasses power and data port 589 housed within the temple arm of AR/VR glasses 590, such that the pin contacts in the universal magnetic and detachable cord connector 580 move out of electrically conductive contact with the pin contact pads 587 in the glasses power and data port 589.

The transfer of power and data may be ceased via the data and power connection between the AR/VR glasses and the AR/VR control modular computing device in an embodiment at block 824. This may be a consequence of decoupling between the pin contacts in the magnetic and detachable cord connector and the pin contact pads in the glasses power and data port.

At block 826, it may be determined whether the touch drawing pad is operatively coupled to the AR/VR control modular computing device, and thus, whether the recently disconnected AR/VR power and data transfer cord was operatively coupled to the touch drawing pad or to either the AR/VR mobile clip device or the AR/VR control modular computing device docking station. This may dictate the method for storing the recently disconnected AR/VR power and data transfer cord in various embodiments herein. If the recently disconnected AR/VR power and data transfer cord was operatively coupled to the touch drawing pad, the method may proceed to block 830 for storage of the recently disconnected AR/VR power and data transfer cord within the housing of the touch drawing pad. If the recently disconnected AR/VR power and data transfer cord was operatively coupled to either the AR/VR glasses mobile clip or the AR/VR control modular computing device docking station, the method may proceed to block 828 for storage of the recently disconnected AR/VR power and data transfer cord within the housing of either the AR/VR mobile clip or the AR/VR control modular computing device docking station, respectively.

In an embodiment at block 828 in which the touch drawing pad is not operatively coupled to the AR/VR control modular computing device and the recently disconnected AR/VR power and data transfer cord was instead operatively coupled to either the AR/VR glasses mobile clip or the AR/VR control modular computing device docking station, the user may tug on the AR/VR power and data transfer cord to initiate retraction of the AR/VR power and data transfer cord into the cord channel and housing of the attached AR/VR glasses mobile clip device or the attached AR/VR control modular computing device docking station. The universal magnetic and detachable cord connector in such an embodiment may also return to the magnetic cradle in the housing of either the AR/VR glasses mobile clip device or the AR/VR control modular computing device docking station for magnetic coupling with the magnetic stay of the universal magnetic and detachable cord connector. For example, in embodiments described with respect to FIGS. 7A and 7B, when disconnected from the AR/VR glasses 790, a universal magnetic and detachable cord connector 780 may magnetically latch to the AR/VR glasses mobile clip device 720 within a magnetic cord connector housing 774 in the cord channel 772 for ease of storage. The method for connecting and disconnecting an AR/VR control modular computing device with AR/VR glasses using a universal magnetic and detachable cord connector that can be positioned in a plurality of orientations with respect to the AR/VR glasses may then end.

At block 830, in an embodiment in which the touch drawing pad is operatively coupled to the AR/VR control modular computing device and the recently disconnected cord was operatively coupled to the touch drawing pad, the user may wind the cord around cord wind mount in touch drawing pad housing bottom surface. The user in such an embodiment may further place the magnetic and detachable cord connector in the magnetic cradle in the housing for the touch drawing pad. For example, in embodiments described with respect to FIGS. 6A, 6B, and 6C, in which the touch drawing pad 670 is operatively coupled to the AR/VR control modular computing device and the user disconnects the cord 691 from the AR/VR glasses, the user may wind the cord 691 around cord wind mount 698 in the touch drawing pad housing 673 bottom surface. Upon winding the cord 691 around cord wind mount 698 in the touch drawing pad housing 673 bottom surface, the user may further place the magnetic and detachable cord connector 680 in the magnetic cradle 674 in the housing 673 for the touch drawing pad 670. In such a way, embodiments of the present disclosure may allow for variable cord length, variable point of attachment on the AR/VR glasses for such an AR/VR power and data transfer cord, and variable cord draping angles with respect to the user, to maximize user comfort and flexibility. The method for connecting and disconnecting an AR/VR control modular computing device with AR/VR glasses using a magnetic and detachable cord connector that can be positioned in a plurality of orientations with respect to the AR/VR glasses may then end.

The blocks of the flow diagram of FIG. 8 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those capable in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. An augmented reality/virtual reality (AR/VR) control modular computing device docking station comprising:
a docking station hardware processor, and a memory disposed in a docking station housing of the AR/VR control modular computing device docking station;
the docking station housing having a secure mating rail formed onto a surface of the docking station housing for operative coupling with a secure mating channel of an AR/VR control modular computing device that generates AR or VR projected image data for display within AR/VR glasses operatively coupled to the AR/VR control modular computing device docking station via an AR/VR power and data transfer cord during operation of the AR/VR glasses;
the AR/VR power and data transfer cord having a magnetic and detachable cord connector for operative coupling with the AR/VR glasses via magnetic attachment between a cord magnetic stay in the magnetic and detachable cord connector and a glasses magnetic stay of a power and data port housed on the AR/VR glasses that is operatively coupled via electrically conductive contact between pin contacts within the magnetic and detachable cord connector and pin contact pads in the power and data port for transfer of the AR or VR projected image data to display projector electronics of the AR/VR glasses; and
a magnetic and detachable cord connector housing of the magnetic and detachable cord connector having a plurality of cord positioning channels in a cord positioning cavity for user selection of orientation of the AR/VR power and data transfer cord in a first configuration with respect to the AR/VR glasses upon operative coupling of the magnetic and detachable cord connector with the power and data port.

2. The AR/VR control modular computing device docking station of claim 1 further comprising:
a retractable AR/VR power and data transfer cord housing within the docking station housing enclosing a retractable spooling device for winding of the power and data transfer cord into a stowed position and magnetically coupling the magnetic and detachable cord connector in a magnetic cradle upon operative disconnection of the AR/VR glasses from the AR/VR power and data transfer cord; and
the retractable spooling device for unwinding of the AR/VR power and data transfer cord to user-specified variable lengths during operative connection of the AR/VR power and data transfer cord to the AR/VR glasses.

3. The AR/VR control modular computing device docking station of claim 1 further comprising:
the docking station housing including a magnetic cradle for magnetic attachment to the cord magnetic stay of the magnetic and detachable cord connector upon placing the AR/VR power and data transfer cord into a stowed position when disconnected from the AR/VR glasses.

4. The AR/VR control modular computing device docking station of claim 1 further comprising:
the magnetic and detachable cord connector housing having a flexible cord directional adjustment jacket actuatable by a user to access the cord positioning cavity to adjust a position of the AR/VR power and data transfer cord within the plurality of cord positioning channels to a second configuration and to lock the AR/VR power and data transfer cord into a user selected one of the plurality of cord positioning channels for the second configuration.

5. The AR/VR control modular computing device docking station of claim 1, wherein the magnetic and detachable cord connector housing of the magnetic and detachable cord connector includes at least two cord positioning channels in the cord positioning cavity for user selection of orientation of the AR/VR power and data transfer cord in a straight configuration or a down configuration with respect to the AR/VR glasses upon operative coupling of the magnetic and detachable cord connector with the power and data port on a temple arm of the AR/VR glasses.

6. The AR/VR control modular computing device docking station of claim 1 further comprising:
the secure mating rail formed onto a surface of the docking station housing with a secure connector pin mount on the secure mating rail for operatively coupling to an AR/VR secure connector port housed within the AR/VR control modular computing device and actuatable into the secure mating channel of the AR/VR control modular computing device that is reciprocal to the secure mating rail.

7. The AR/VR control modular computing device docking station of claim 1 further comprising:
the docking station hardware processor to provide augmented hardware processing resources to the AR/VR control modular computing device for generating AR or VR projected image data for display within AR/VR glasses pursuant to execution of machine readable code instructions of one or more software applications; and
AR/VR control modular computing device docking station providing wireless or wired operative coupling to one or more peripheral input/output devices for operation with the AR/VR glasses within a user workspace.

8. An augmented reality/virtual reality (AR/VR) glasses mobile clip device comprising:
a mobile clip housing having a secure mating rail formed onto a surface of the mobile clip housing for operative coupling with an AR/VR control modular computing device that generates AR or VR projected image data for display within AR/VR glasses operatively coupled to the AR/VR glasses mobile clip device via an AR/VR power and data transfer cord during operation of the AR/VR glasses;
the mobile clip housing enclosing a retractable spooling device for winding of the power and data transfer cord into a stowed position upon operative disconnection of the AR/VR glasses from the AR/VR power and data transfer cord;
the AR/VR power and data transfer cord having a magnetic and detachable cord connector for operative coupling with the AR/VR glasses via magnetic attachment between a cord magnetic stay in the magnetic and detachable cord connector and a glasses magnetic stay of a power and data port housed on the AR/VR glasses that is operatively coupled via electrically conductive contact between pin contacts within the magnetic and detachable cord connector and pin contact pads in the power and data port for transfer of the AR or VR projected image data to display projector electronics of the AR/VR glasses; and
a magnetic and detachable cord connector housing of the magnetic and detachable cord connector having a plurality of cord positioning channels in a cord positioning cavity for user selection of orientation of the AR/VR power and data transfer cord in a first configuration with respect to the AR/VR glasses upon operative coupling of the magnetic and detachable cord connector with the power and data port.

9. The AR/VR glasses mobile clip device of claim 8 further comprising:
the mobile clip housing including a cord channel and magnetic cradle to magnetically couple the AR/VR power and data transfer cord having a magnetic and detachable cord connector for storage in the stowed position upon operative disconnection of the AR/VR glasses from the AR/VR power and data transfer cord; and
the retractable spooling device for unwinding of the power and data transfer cord to user-specified variable lengths during operative connection of the power and data transfer cord to the AR/VR glasses.

10. The AR/VR glasses mobile clip device of claim 8 further comprising:
the mobile clip housing including a magnetic cradle for magnetic attachment to the cord magnetic stay of the magnetic and detachable cord connector upon winding of the AR/VR power and data transfer cord into the stowed position.

11. The AR/VR glasses mobile clip device of claim 8 further comprising:
the magnetic and detachable cord connector housing including a flexible cord directional adjustment jacket actuatable by a user to access the cord positioning cavity to adjust a position of the AR/VR power and data transfer cord within the plurality of cord positioning channels to a second configuration and to lock the power and data transfer cord into a user selected one of the plurality of cord positioning channels in the second configuration.

12. The AR/VR glasses mobile clip device of claim 8, wherein the magnetic and detachable cord connector housing of the magnetic and detachable cord connector includes at least two cord positioning channels in the cord positioning cavity for user selection of orientation of the AR/VR power and data transfer cord in a straight configuration or a down configuration with respect to the AR/VR glasses upon operative coupling of the magnetic and detachable cord connector with the power and data port on a temple arm of the AR/VR glasses.

13. The AR/VR glasses mobile clip device of claim 8, wherein the magnetic and detachable cord connector housing of the magnetic and detachable cord connector includes the plurality of cord positioning channels in the cord positioning cavity for user selection of orientation of the AR/VR power and data transfer cord in at least an up configuration, a straight configuration or a down configuration with respect to the AR/VR glasses upon operative coupling of the magnetic and detachable cord connector with the power and data port on a temple arm of the AR/VR glasses.

14. The AR/VR glasses mobile clip device of claim 8 further comprising:
the secure mating rail formed onto a surface of the mobile clip housing with a secure connector pin mount on the secure mating rail for operatively coupling to an AR/VR glasses control module secure connector port housed within the AR/VR control modular computing device and actuatable into a reciprocal secure mating channel formed into a housing of the AR/VR control modular computing device.

15. The AR/VR glasses mobile clip device of claim 8 further comprising:
the mobile clip housing formed to provide a clip structure for the AR/VR glasses mobile clip device and the AR/VR control modular computing device securely, operatively coupled via the secure mating rail that is wearable by a user during mobile use of the AR/VR glasses.

16. A touch drawing pad comprising:
a touch drawing pad housing including an interface surface for the touch drawing pad and a bottom cord housing including a cord wind mount, where the touch drawing pad includes a wired communication port for establishing a wired data transfer connection with an augmented reality/virtual reality (AR/VR) control modular computing device that generates AR or VR projected image data for display within AR/VR glasses operatively coupled to the touch drawing pad via an AR/VR power and data transfer cord during operation of the AR/VR glasses;
the bottom cord housing of the touch drawing pad enclosing the cord wind mount with a cord channel for winding of the AR/VR power and data transfer cord into a stowed position upon operative disconnection of the AR/VR glasses from the AR/VR power and data transfer cord;
a magnetic and detachable cord connector for operative coupling with the AR/VR glasses via magnetic attachment between a cord magnetic stay in the magnetic and detachable cord connector and a glasses magnetic stay of a power and data port housed within the AR/VR glasses and that is operatively coupled via electrically conductive contact between pin contacts within the magnetic and detachable cord connector and pin contact pads in the power and data port for transfer of the AR or VR projected image data to display projector electronics of the AR/VR glasses; and
a magnetic and detachable cord connector housing of the magnetic and detachable cord connector having a plurality of cord positioning channels in a cord positioning cavity for user selection of orientation of the AR/VR power and data transfer cord in a first configuration with respect to the AR/VR glasses upon operative coupling of the magnetic and detachable cord connector with the power and data port.

17. The touch drawing pad of claim 16 further comprising:
the bottom cord housing of the touch drawing pad enclosing the cord wind mount having a right side and a left side cord channel for orientation of the AR/VR power and data transfer cord on a user selected side exiting from the bottom cord housing with respect to the cord winding mount of the touch drawing pad for ease use of the touch drawing pad during operation with the AR/VR glasses.

18. The touch drawing pad of claim 16 further comprising:
the cord wind mount for unwinding of the power and data transfer cord to user-specified variable lengths during operative coupling of the AR/VR power and data transfer cord to the AR/VR glasses.

19. The touch drawing pad of claim 16 further comprising:
the bottom cord housing including a magnetic cradle for magnetic attachment to the cord magnetic stay of the magnetic and detachable cord connector upon winding of the power and data transfer cord within the bottom cord housing into the stowed position.

20. The touch drawing pad of claim 16 further comprising:
the magnetic and detachable cord connector housing including a flexible cord directional adjustment jacket actuatable by a user to access the cord positioning cavity to adjust a position of the AR/VR power and data transfer cord within the plurality of cord positioning channels to a second configuration and to lock the power and data transfer cord into a user selected one of the plurality of cord positioning channels in the second configuration.
